(19) United States
(12) Patent Application Publication
(10) Pub. No.: US 2016/0292773 A1
(43) Pub. Date: Oct. 6, 2016

(54) SYSTEM AND METHOD FOR AUTOMATICALLY PURCHASING MULTIPLE ITEMS BASED ON A BUDGET

(71) Applicant: eBay Inc., San Jose, CA (US)

(72) Inventor: Ethan Bickford Martin, Bryn Mawr, PA (US)

(21) Appl. No.: 14/677,919

(22) Filed: Apr. 2, 2015

(51) Int. Cl. G06Q 30/06; G06Q 40/00; G06Q 30/08

(52) U.S. Cl. CPC G06Q 30/0635; G06Q 30/08; G06Q 40/12

(57) ABSTRACT

In various example embodiments, a system and method for automatically purchasing multiple items within a budget are presented. A budget order request associated with a user is received by a budget purchasing system. The budget order request includes item identification information specifying multiple items to be purchased and a budget amount for the budget order request. The budget ordering system generates an estimated budget for the budget order request. The budget order system generates an estimated budget for the purchase order request based on the estimated current pricing and determines the estimated budget is within the budget amount for the budget order request. The budget purchasing system identifies listings associated with the multiple items and automatically selects listings from the identified listings to purchase the multiple items specified in the budget order request within the budget amount specified in the budget order request.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2015, eBay Inc. All Rights Reserved.

### TECHNICAL FIELD

Embodiments of the present disclosure relate generally to data processing and, more particularly, but not by way of limitation, to purchasing multiple items based on a budget.

### BACKGROUND

Online buying continues to grow at a very fast rate. The growth of online buying may be characterized by strong consumer demands and the increasing number of goods available for purchase. In many situations, users may be interested in purchasing multiple items online. Additionally, users may purchase items through an online auction that may offer instant purchasing at a fixed fee.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating a budget purchasing system, according to some example embodiments.

FIG. 3 is a block diagram illustrating a budget module within the budget purchasing system, according to some example embodiments.

FIG. 4 is a block diagram illustrating a purchasing module within the budget purchasing system, according to some example embodiments.

FIG. 5 illustrates a budget order request record with example fields used to implement various embodiments of the budget purchasing system.

FIG. 6A illustrates a budget order request record for a toaster example, according to one embodiment.

FIG. 6B illustrates a budget order request record for a planter example, according to another embodiment.

FIG. 6C illustrates a budget order request record for a garden example, according to a further embodiment.

FIG. 7A illustrates a budget order request table corresponding to the budget order request record shown in FIG. 6B, according to an example embodiment.

FIG. 7B illustrates an estimated budget table having records associated with the budget order request table shown in FIG. 7A, according to an example embodiment.

FIG. 7C illustrates an example user interface displaying a recommendation from the budget purchasing system, according to an example embodiment.

FIG. 7D illustrates an estimated budget table having records associated with the budget order request table shown in FIG. 7A, according to another example embodiment.

FIG. 7E illustrates an example user interface displaying recommended spending by item from the budget purchasing system, according to an example embodiment.

FIG. 8A illustrates a budget order request table corresponding to the budget order request record shown in FIG. 6C, according to another example embodiment.

FIG. 8B illustrates an estimated budget table having records associated with the budget order request table shown in FIG. 8A, according to an example embodiment.

FIG. 8C illustrates an example user interface displaying recommended spending by item type from the budget purchasing system, according to an example embodiment.

FIG. 8D illustrates a budget order request table corresponding to the budget order request record shown in FIG. 6A, according to another example embodiment.

FIG. 8E illustrates a product recommendation table corresponding to the budget order request table shown in FIG. 8C.

FIG. 8F illustrates a user interface showing a recommendation for available items associated with an individual item specified in the budget order request.

FIG. 8G illustrates a selected listing table, according to an example embodiment.

FIG. 9 illustrates database tables that may be used by the budget purchasing system, according to example embodiments.

FIG. 10A is a flow diagram illustrating a method for purchasing multiple items based on a budget order request, according to example embodiments.

FIG. 10B is a flow diagram illustrating a method for identifying an individual item from the multiple items specified in the budget order request, according to example embodiments.

FIG. 10C is a flow diagram illustrating a method for determining a specified order for placing orders with the selected listings, according to an example embodiment.

FIG. 10D is a flow diagram illustrating a method for automatically placing orders with the selected listings based on the specified order, according to another example embodiment.

FIG. 11 is a block diagram illustrating an example of a software architecture that may be installed on a machine, according to some example embodiments.

FIG. 12 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program items that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, a budget purchasing system for purchasing multiple items specified in a budget order request is described. In one example embodiment, the budget purchasing system includes a communications module that is configured to receive a budget order request associated with a user. The budget order request includes item identification information to specify multiple items in a budget order request and a budget amount for the budget order request. In example embodiments, the budget amount includes the item purchase amounts, shipping or delivery fees, applicable taxes, and other fees. The budget purchasing system includes a budget module that is configured to estimate the current pricing associated with the items specified in the budget order request based on historical data accessed from a database. The budget module is also configured to generate an estimated budget for the budget order request based on the estimated current pricing associated with the items specified in the budget order request. The budget module is further configured to determine whether the estimated budget is within the budget amount for the budget order request. The budget module is also configured to identify listings associated with the items specified in the budget order request based on the item identification information and the budget estimates for the individual items specified in the budget order request.

In further embodiments, the budget purchasing system includes a budget module configured to select listings from the identified listings for automatically placing orders or bidding. The selected listings may include auction formatted listings, fixed fee listings, or a combination of both auction formatted and fixed fee listings. The budget purchasing system may also include a purchasing module configured to automatically place orders with the selected listings in a specified order. The automatic placement of orders includes placing bids if the selected listing is an auction formatted listing The specified order for placing orders with selected listings may include placing orders with multiple listings concurrently, or placing sequential orders with multiple listings.

In other embodiments, the budget module is configured to track spending associated with purchased items from selected listings and to reallocate un-used budget allocated to the purchased items to the unpurchased items. The budget module is further configured to identify and split updated listings available for purchasing the unpurchased items.

In another example embodiment, the budget order request includes a requested delivery date specified by a purchaser as to when items specified in the budget order request are to be purchased and delivered. The budget purchasing system determines the order for placing orders with selected listings to purchase the items specified in the budget order request based on various criteria such as the requested delivery date. The selected listings may include auction formatted listings and fixed fee listings. In some embodiments, the budget purchasing system determines whether the requested delivery date provides sufficient time to purchase one or more items from auction formatted listings prior to purchasing one or more items from fixed fee listings. In other embodiments, the budget purchasing system also determines whether to place two or more concurrent orders with the selected listings for the items specified in the budget order request. In further embodiments, the budget purchasing system further determines whether to place two or more sequential orders with the selected listings to purchase the items specified in the budget order request. The budget purchasing system may automatically place orders with the selected listings based on a specified order determined by various criteria.

In another embodiment, the budget purchasing system includes a recommendation module that is configured to generate a recommendation based on the estimated budget generated by the budget module. The estimated budget may include budget estimates for the individual items specified in the budget order request. The recommendation may include proposed spending for the items specified in the budget order request by individual items or by item type, which may include more than one item. In some embodiments, the recommendation module is configured to provide a recommendation to increase the budget amount; modify or replace one or more items in the budget order request; or cancel the budget order request order if the estimated budget exceeds the budget amount.

In various embodiments, a method for purchasing multiple items specified in a budget order request is described. The budget purchasing system receives a budget order request associated with a user. The budget order request includes item identification information to specify multiple items and a budget amount. The multiple items in the budget order request represent at least one item type. For an example embodiment, an item type may represent a listing classification. The budget purchasing system estimates current pricing for the items specified in the budget order request or for the item types, based on historical data accessed from a database. The budget purchasing system generates an estimated budget for the budget order request based on the estimated current pricing for the items specified in the budget order request. The estimated budget includes budget estimates for the individual items or the item types. The budget purchasing system determines if the estimated budget is within the budget amount for the budget order request. The budget purchasing system identifies listings associated with the multiple items specified in the budget order request based on the item identification information and the budget estimates for the individual items. In some embodiments, the budget estimates may be for item types rather than individual items. The budget purchasing system selects listings from the identified listings to purchase the items specified in the budget order request. The budget purchasing system automatically places orders with the selected listing in a specified order to purchase the items specified in the budget order request within the budget amount for the budget order request, and in some cases, within the requested delivery date specified in the budget order request.

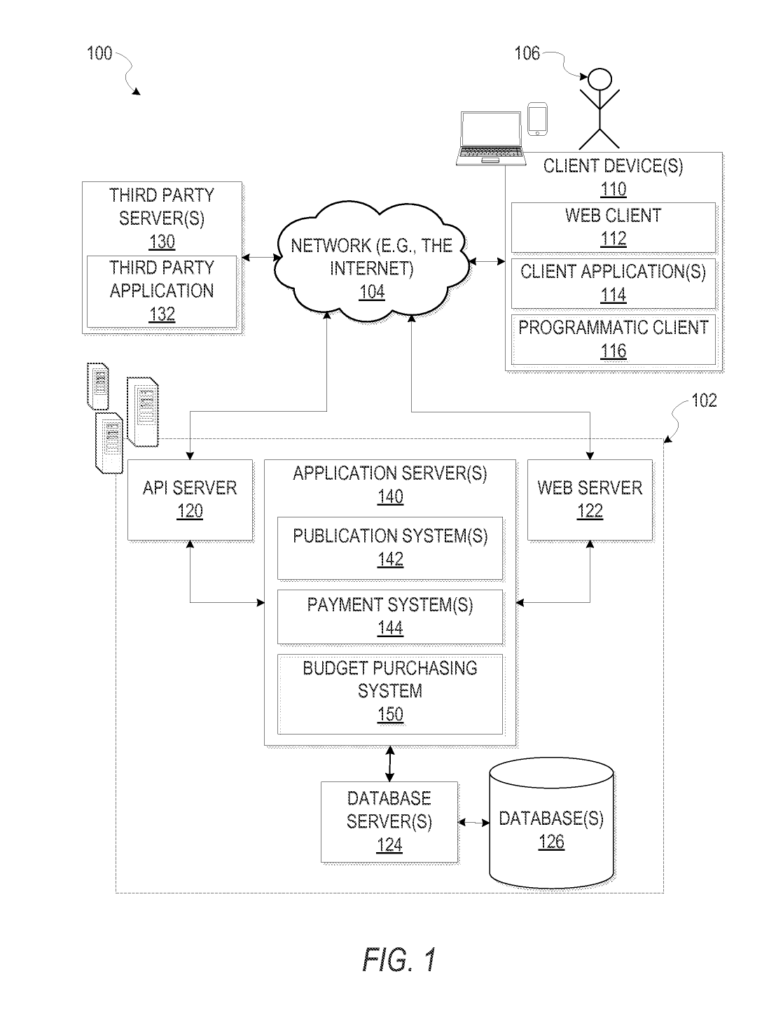

With reference to FIG. 1, an example embodiment of a high-level client-server-based network architecture 100 is shown. A networked system 102, in the example forms of a network-based publication or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

In various embodiments, the application 114 may be a web application that enables a user 106 to execute a budget purchasing application on the client device 110. The budget purchasing application enables the user 106 to log into a budget purchasing system 150 and submit a budget order request. The budget order request will be described in further detail below. The budget purchasing application running on the client device 110 also enables the user to view recommendations from the budget purchasing system 150 and enables the user to provide responses to those recommendations.

The client devices 110 may comprise, but are not limited to, a mobile phone, desktop computer, laptop, personal digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of items available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a wireless fidelity (WiFi) network, a worldwide interoperability for microwave access (WiMax) network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client devices 110, then this application is configured to locally provide the user interface and at least some of the functionalities, with the application configured to communicate with the networked system 102, on an as needed basis, for data and/or processing capabilities not locally available (e.g., access to a database of items available for sale, authentication of a user, verification of a method of payment, etc.). Conversely, if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information, in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The budget purchasing system 150 may provide functionality operable to perform purchases for multiple items within a budget amount for a budget order request. For example, the budget purchasing system 150 may access data from the databases 126, the third party servers 130, the publication system 142, and other sources. In some example embodiments, the budget purchasing system 150 may analyze the data provided in the budget order request to perform multiple item purchases from listings available from a publication system 142. The budget order request may include item identification information for the multiple items, a budget amount for the budget order request, and a requested delivery date for the multiple items.

In further embodiments, if the budget purchasing system 150 is not able to fulfil the budget order request based on listings available from the publication system 142, the budget purchasing system 150 may recommend listings available from an external publication or marketplace system. Using data received from the budget order request, the budget purchasing system 150 identifies listings associated with the multiple items and selects listings from the identified listings to fulfil the budget order request. The budget order request may represent a purchase order placed by a user 106 to purchase the multiple items within a specified budget amount, and in some embodiments, by a requested delivery date.

In example embodiments, the budget purchasing system 150 automatically places one or more orders with selected listings from the publications system 142, on behalf of a user 106, to purchase the items specified in the budget order request in a specified order. For example, the orders may be placed on auction format listings by having the budget purchasing system 150 place bids, or the orders may be placed on fixed fee listings. The order for placing orders with selected listings to purchase the items specified in the budget order request may be managed by the budget purchasing system 150. One or more orders may be placed with the selected listings concurrently, and one or more orders may be placed with the selected listings sequentially.

The budget purchasing system 150 may use certain criteria to determine the sequence for placing orders for a budget order request to obtain the multiple items within the budget amount, and in some cases by a requested delivery date. Examples of criteria used by the budget management system 150 to determine when to place an order for a budget order request includes the budget amount, the requested delivery date, estimated current pricing for individual items from the multiple items or item types, bidding information (e.g., start and end of bids for an auction formatted listing), type of listing (auction format versus fixed fee listings), and source of the available listing (internal or external to the publication system 142).

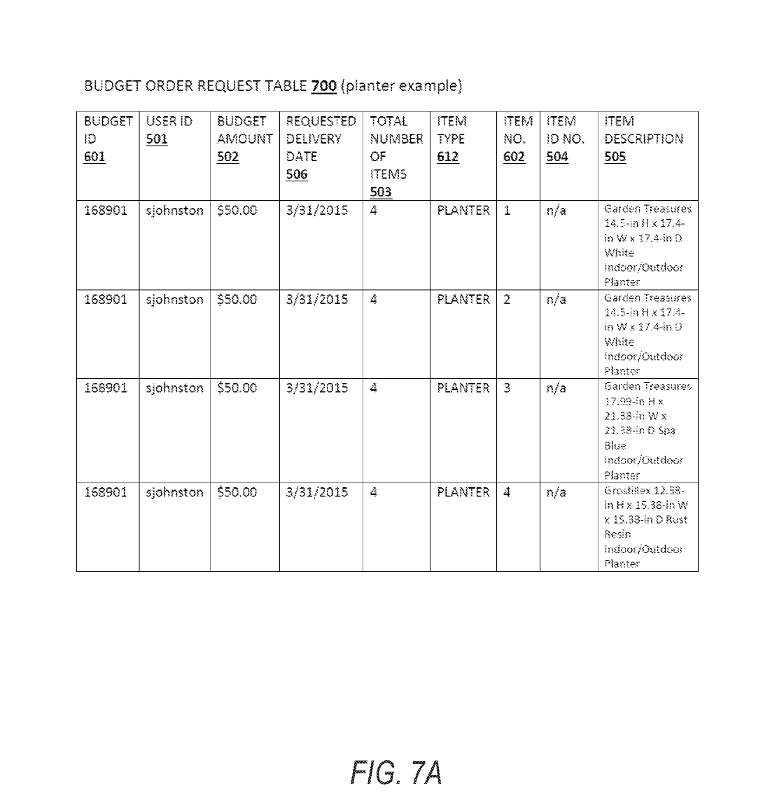

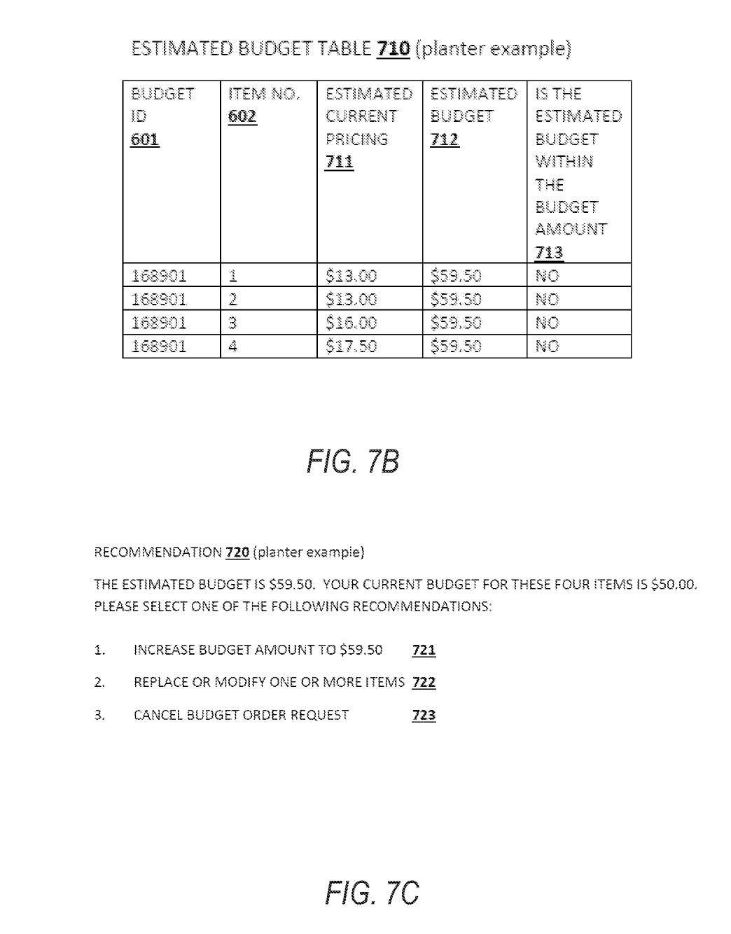

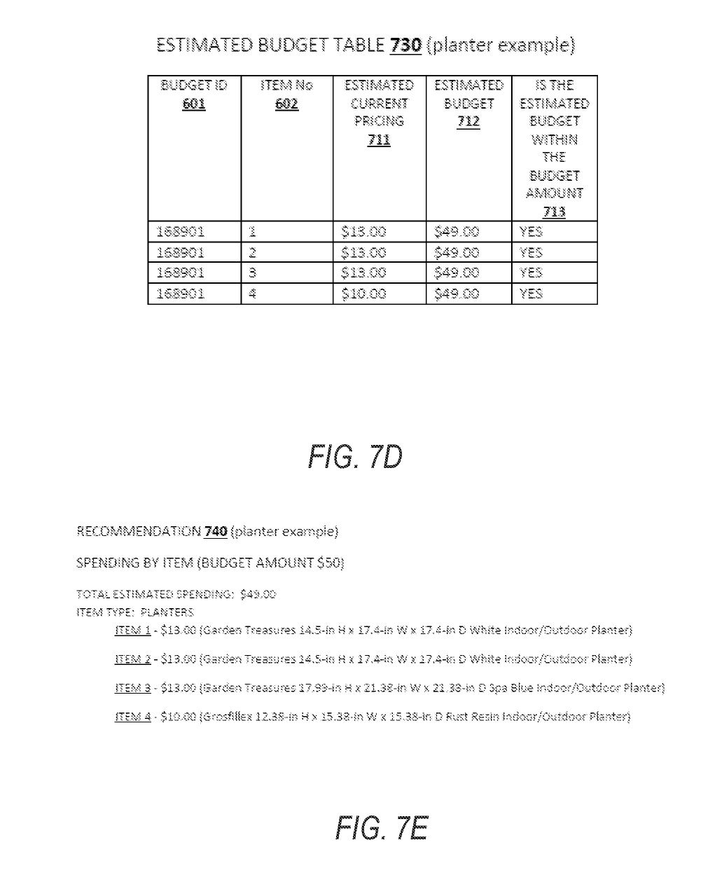

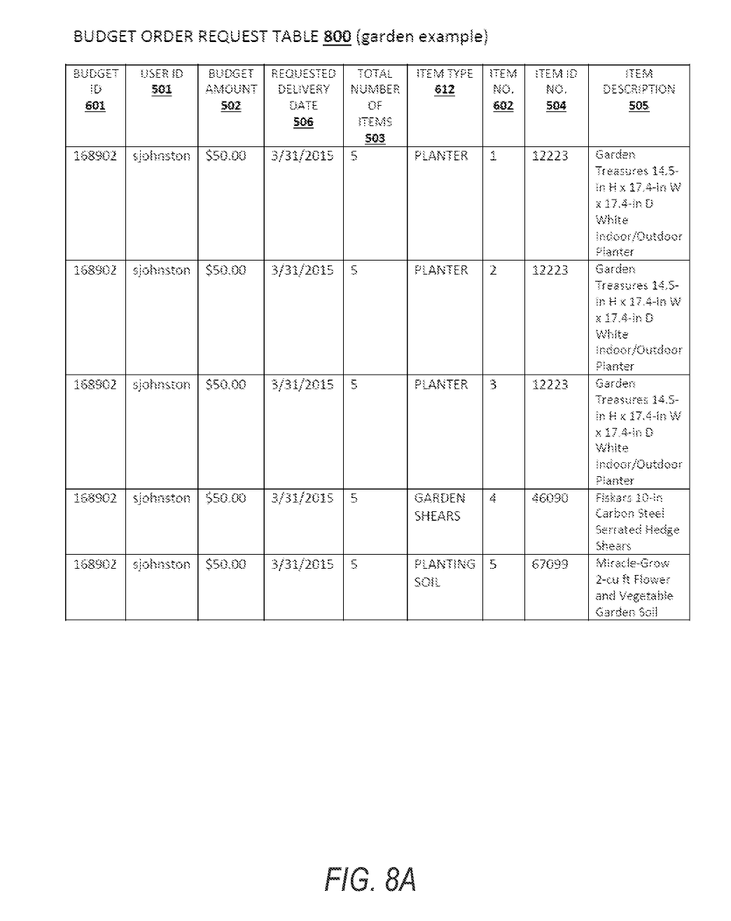

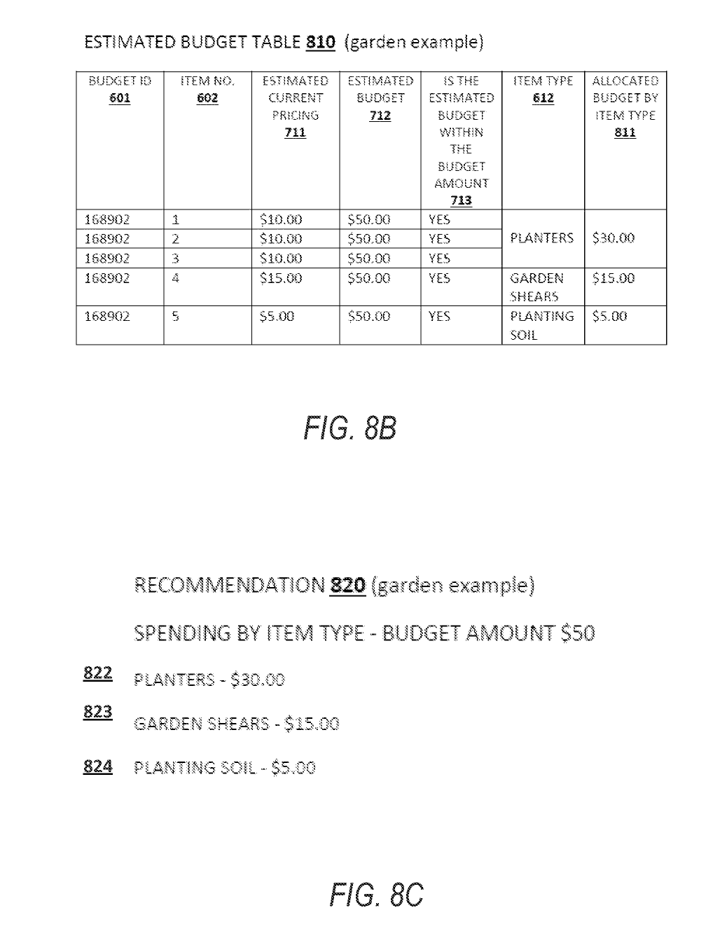

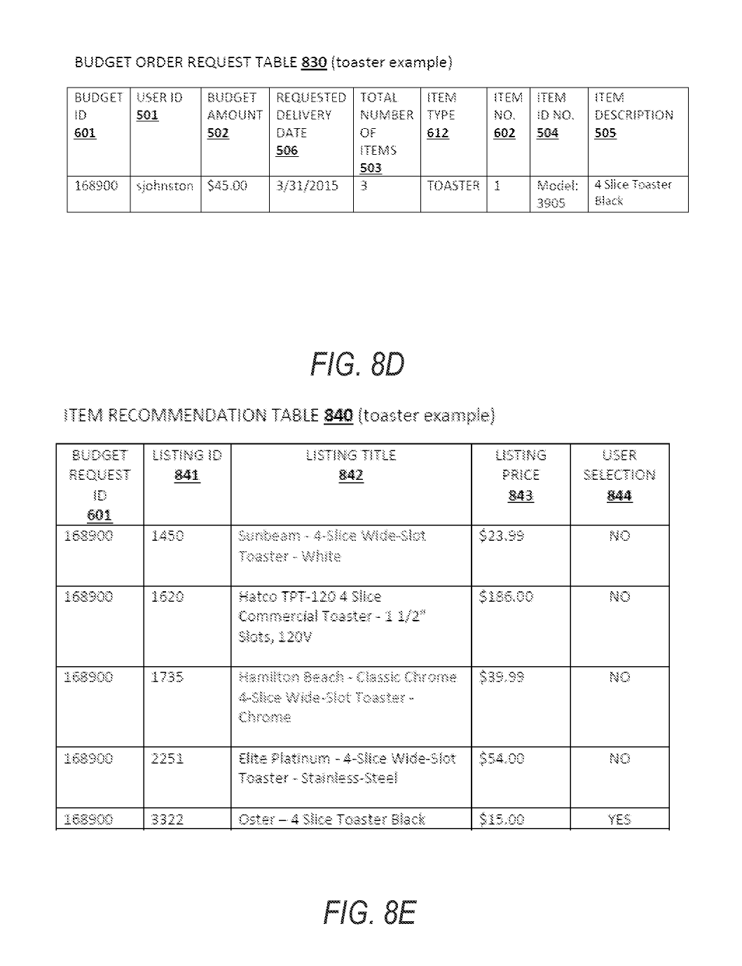

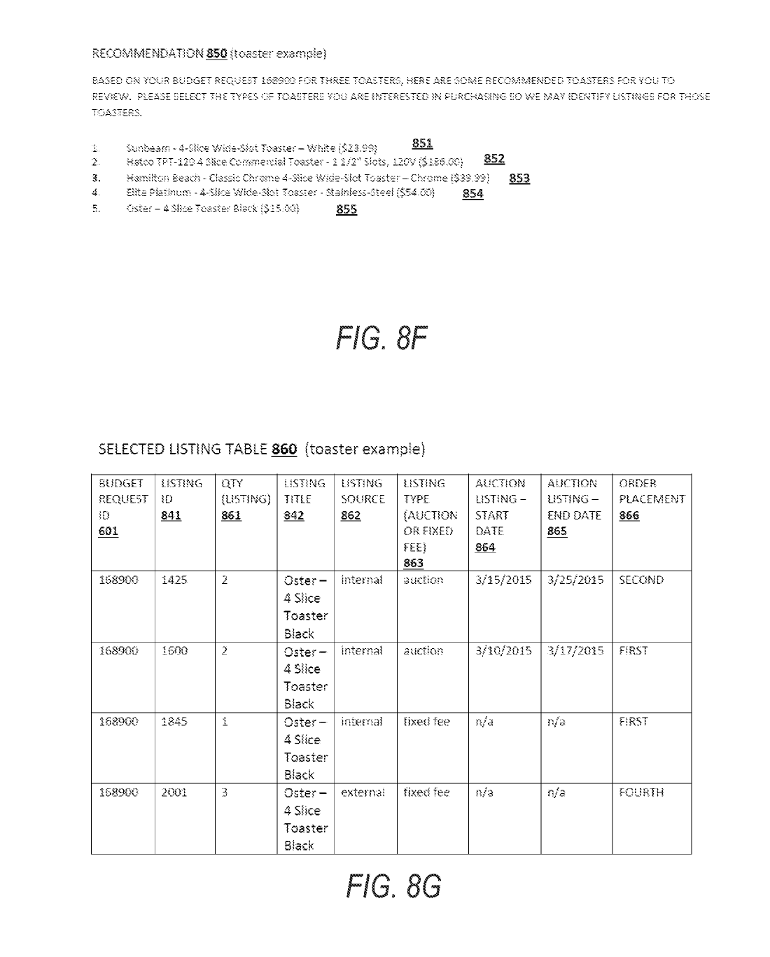

In various embodiments, the budget purchasing system 150 may represent an interactive system with a user 106 that provides functionality to fulfil the budget order request. Various embodiments of the budget purchasing system 150 may provide recommendations to the user 106. For example, after performing some pricing analysis (for the multiple items or item types specified in the budget order request) based on historical data available from the networked system 102, the budget purchasing system 150 may generate a budget estimate for the budget order request and may provide a recommendation that is displayed via a client device 110 to a user 106. In one example, the recommendation may be for the user 106 to increase the budget amount for the budget order request. (See FIG. 7C) In another example, the recommendation may provide the user 106 with recommended spending of the budget amount by individual items from the multiple items or item types. (See FIGS. 7E and 8C). In some embodiments, the user 106 may provide additional input to further refine the example listings selected by the budget purchasing system 150. In other embodiments, the budget purchasing system 150 may provide item recommendations based on the item identification information provided in the budget order request. The item recommendations may be presented to the user 106 via the client device 110 and allow the user 106 to select one or more items recommended. The items may be recommended with the example listings selected by the budget purchasing system 150. Based on the input provided by the user 106, the budget purchasing system 150 may identify listings associated with the items selected. (See FIG. 8F).

In some example embodiments, the budget purchasing system 150 may communicate with the publication systems 120 (e.g., accessing item listings) and payment system 144. In an alternative embodiment, the budget purchasing system 150 may be a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and budget purchasing system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

Additionally, a third party application(s) 132, executing on a third party server(s) 130, is shown as having programmatic access to the networked system 102 via the programmatic interface provided by the API server 120. For example, the third party application 128, utilizing information retrieved from the networked system 102, may support one or more features or functions on a website hosted by the third party. The third party website may, for example, provide one or more promotional, marketplace, or payment functions that are supported by the relevant applications of the networked system 102.

In an example embodiment, multiple applications or engines (not shown) which may be included within the publication system 142 may be provided as part of the networked system 102. These applications may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 126 via the database servers 124.

For example, the networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 142 may include at least one publication application and one or more auction applications which support auction format listing. The various auction applications may also provide a number of features in support of such auction format listings, such as a reserve price feature whereby a seller may specify a reserve price in connection with a listing and a proxy-bidding feature whereby a bidder may invoke automated proxy bidding.

The publication system 142 may include a number of fixed-price applications that support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

In some embodiments, searching the networked system 102 is facilitated by a searching engine (not shown). For example, the searching engine enables keyword queries of listings published via the networked system 102. In example embodiments, the searching engine receives the keyword queries from the budget purchasing system 150 and conducts a review of the storage device storing the listing information. The review will enable compilation of a result set of listings that may be sorted and returned to the budget purchasing system 150, which may return some or all of the results to the client device (e.g., client devices 110) of the user. The searching engine may record the query (e.g., keywords) and any subsequent actions and behaviors performed by the budget purchasing system 150 (e.g., navigations, selections, or click-throughs).

In further embodiments, a navigation engine (not shown) allows the budget purchasing system 150 to navigate through various categories, catalogs, or inventory data structures according to which listings may be classified within the networked system 102. For example, the navigation engine allows the budget purchasing system 150 to successively navigate down a category tree comprising a hierarchy of categories (e.g., the category tree structure) until a particular set of listings is reached. Various other navigation applications within the navigation engine may be provided to supplement the searching and browsing applications.

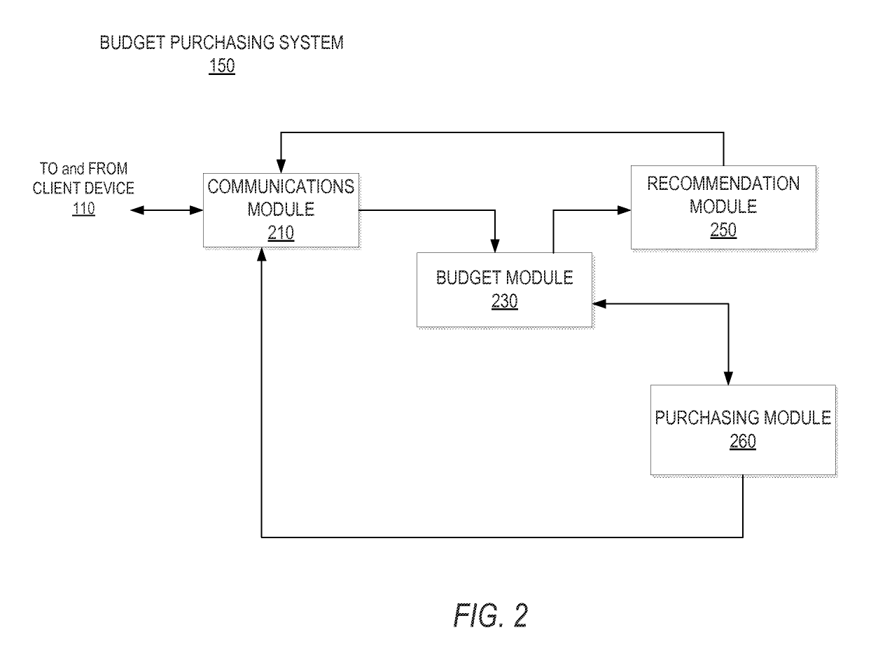

FIG. 2 is a block diagram illustrating the budget purchasing system 150, according to some example embodiments. In an example embodiment, the budget purchasing system 150 includes a communications module 210, a budget module 230, a recommendation module 250 and a purchasing module 260. All, or a portion, of the modules 210, 230, 250, and 260 may communicate with each other, for example, via a network coupling, shared memory, and the like. It will be appreciated that the modules 210, 230, 250, and 260 may be implemented as a single module, combined into other modules, or further subdivided into multiple modules. It will further be appreciated that the modules or functionality of the budget purchasing system 150 may be implemented in publication system(s) 142 or the payment system(s) 144. Other modules not pertinent to example embodiments may also be included, but are not shown in FIG. 2.

The communications module 210 may provide various communications functionality. For example, network communication such as communicating with networked system 102, the database servers 124, and the third party servers 130 may be provided. In various example embodiments, the network communications may operate over any wired or wireless means to provide communication functionality. Information retrieved by the communications module 210 comprise data associated with the user 106 (e.g., user profile information from an online account), data associated with a budget order request (e.g., budget amount and identification information of multiple items), data associated with an item (e.g., item identification information, and item description), and other data (user input in response to recommendations by the budget purchasing system 150). The communications module 210 may also include user interface functionality operable to interactively present information to a user, such as user 106. For example, the communications module 210 may enable recommendations generated by the budget purchasing system 150 to be presented to a user. In various embodiments, presenting is intended to include communicating information to another device, such as device 110, with functionality operable to perform presentation using the communicated information.

The budget module 230, the recommendation module 250, and the purchasing module 260 each provide various logic functions to facilitate the operation of the budget purchasing system 150.

Once a user is logged into the budget purchasing system 150 via a client device, he or she may submit a budget order request to the budget purchasing system 150. In various embodiments, the communications module 210 receives the budget order request from a user device, such as client device 110. The budget order request includes user specified information related to multiple items a user would like the budget purchasing system 150 to purchase on his or her behalf. The budget module 230 receives the budget order request from the communications module 210.

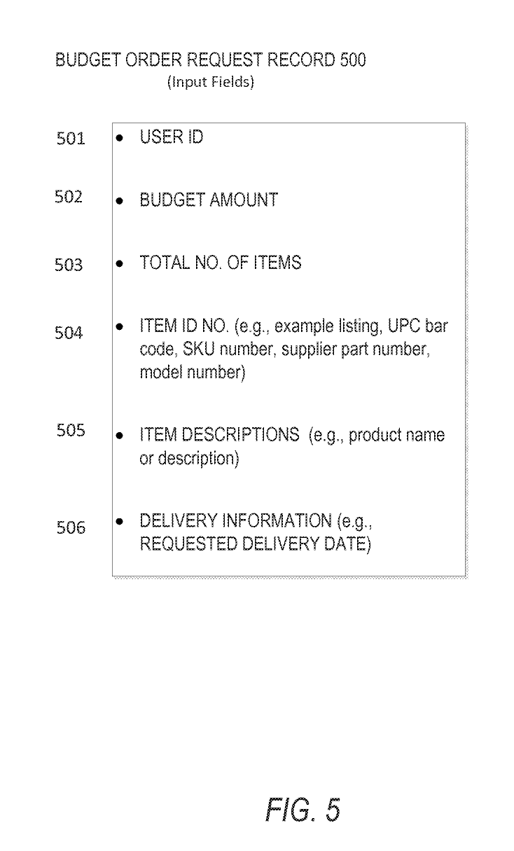

Referring to FIG. 5, examples of fields included within a budget order request record 500 are shown. The budget order request record 500 from the user may include a user id 501, a budget amount 502, a total number of items 503 included in the budget order request, item id no. 504, item description 505, and delivery information 506 or combinations thereof. The delivery information 506 may include the specified address where the items are to be delivered and the requested delivery date. In various embodiments, the budget order request is used to specify item identification information sufficient to enable the budget purchasing system 150 to identify example item listings. The budget order request may provide the item id no. or the item description, or both the item id no. and the item description. The item id no. may represent a variety of item identification numbers such as listing reference numbers, Universal Product Code (UPC) bar codes, stock keeping unit (SKU) numbers, supplier part numbers, model numbers and so forth. The item descriptions may include the name of an item or other description of an item. The information provided in the budget order request is stored in a budget order request record of a budget order request table.

In various embodiments, the budget module 230 is responsible for selecting the listings and specifying the order for placing orders with the selected listings to purchase the items specified in the purchase order request. The budget module 230 provides functionality to evaluate the budget order requests to identify the multiple items the user is requesting to purchase, generate an estimated budget for purchasing the multiple items, and select listings for placing orders to purchase the multiple items. The budget order request is fulfilled when the items specified in the budget order request are purchased within the budget amount for the budget order request and by the requested delivery date specified in the budget order request.

When evaluating the budget order requests to identify the multiple items, the budget module 230 may determine that one or more of the items represent the same item, one or more of the items represent similar items, and one or more of the items represent different items. During the process of estimating the budget for the budget order request, the budget module 230 estimates current pricing associated with the items specified in the budget order request. The analysis performed by the budget module 230 to compute the estimated current pricing is based on historical data accessed from one or more databases (e.g., databases 126) within the networked system 102 or may be accessed from databases external to the networked system 102. The historical data available to the networked system 102 may include past and current listings associated with the multiple items, transactions associated with multiple items, and other item identification information useful in determining the estimated current pricing.

In some examples, the estimated current pricing may represent equilibrium pricing or competitive pricing. Based on the historical data available to the budget module 230, the budget model 230 may determine the market price (based on supply and demand) for an item established through competition such that the amount of goods or services sought by buyers is equal to the amount of goods or services produced by sellers. In other embodiments, the estimated current pricing may be estimated based on other factors.

The budget module 230 provides input to the recommendation module 250, which generates recommendations for the user. The recommendations generated by the recommendation module 250 are provided to the communications module 210. The communications module 210 sends the recommendations to the client device for presentation to the user.

FIG. 7C illustrates a user interface that displays a recommendation 720 for one embodiment. In one example, the budget module 230 estimates a budget for the budget order request that exceeds the budget amount. The recommendation module 250 may recommend three options 721, 722 and 723 to the user. The option 721 recommends increasing the budget amount. The option 722 recommends replacing or modifying one or more items specified in the budget order request. The option 723 recommends canceling the budget order request.

FIG. 7E illustrates a user interface that displays a recommendation 740 for another embodiment. The recommendation 740 recommends spending by item. In some embodiments, the recommendation by spending is based on the estimated current pricing by the budget module 230. As shown in FIG. 7E, the recommended spending for item 1 is $13.00, the recommended spending for item 2 is $13.00, the recommended spending for item 3 is $13.00, and the recommended spending for item 4 is $10.00. In other embodiments, the user interface may provide one or more user interface elements that allow the user to accept, decline, or modify the recommendation 740.

FIG. 8C illustrates a user interface that displays a recommendation 820. The recommendation 820 recommends spending by item type. FIG. 8C illustrates an item type 822 for planters, an item type 823 for garden shears, and an item type 824 for planting soil. In other embodiments, the user interface may provide one or more user interface elements that allow the user to accept, decline, or modify the recommendation 820.

FIG. 8F illustrates a user interface that displays a recommendation 850. The recommendation 850 recommends items (e.g., toasters) for the user to review and provide feedback on. The recommendation 850 displays 5 different types or brands of toasters. The item 851 represents a Sunbeam toaster, the item 852 represents a Hatco TPT toaster, the item 853 represents a Hamilton Beach toaster, the item 854 represents an Elite Platinum toaster, and the product 855 represents an Oster toaster. In various embodiments, the user interface provides one or more user interface elements that allow the user to select one or more of the items presented on the client device.

In an example embodiment, the recommendation module 250 is configured to generate a recommendation, based on the estimated budget provided by the budget module 230, for proposed spending by the individual items or by item types.

Referring back to FIG. 2, the budget module 230 communicates with the purchasing module 260 to provide instructions to place orders with selected listings. The purchasing module 260 informs the budget module 230 which orders are placed with the selected listings or items purchased from the selected listings. This allows the budget module 230 to track spending as the individual items specified in the budget order request are being purchased until the purchasing module 260 completes the purchase for the budget order request. By tracking the spending of the individual items as they are being purchased, the budget module 230 may re-allocate unused budget associated with purchased items to unpurchased items. In various embodiments, the budget allocated to any unpurchased items may be adjusted dynamically by the budget module 230.

In other embodiments, the budget module 230 manages the order in which the individual items are purchased based on certain criteria. Examples of criteria include the budget amount, the requested delivery date, estimated current pricing for individual items from the multiple items or item types, bidding information (e.g., start and end of bids for an auction formatted listing), type of listing (auction format listings versus fixed fee listings), and source of the available listing (internal or external to the publication system 142). In alternative embodiments, other criteria may be used.

The purchasing module 260 provides functionality to purchase items from identified and selected listings available from the networked system 102. In various embodiments, the purchasing module 260 automatically places orders with the selected listings in a specified order defined by the budget module 230. In other embodiments, the purchasing module 260 may provide recommendations to purchase items from sources external to the networked system 102. In example embodiments, the purchasing module 260 may provide functionality to purchase the multiple items from auction formatted listings, fixed priced listings, or a combination of auction formatted listings and fixed priced listings.

In some embodiments, as transactions are completed by the purchasing module 260, information regarding the completed transactions is sent from the purchasing module 260 to the communications module 210. In other embodiments, information regarding the completed transactions is sent from the purchasing module 260 to the budget module 230, which then forwards the information regarding the completed transactions to the communications module 210. In some embodiments, the budget module 230 may use information regarding the completed transactions to revise the estimated budget for the unpurchased items or item types, adjust the order of placing orders with the selected listings, or select new listings to place orders. The new listings may represent a different listing type (auction formatted listing versus fixed fee listings). The new listings may be available from a different listing source (internal versus external system).

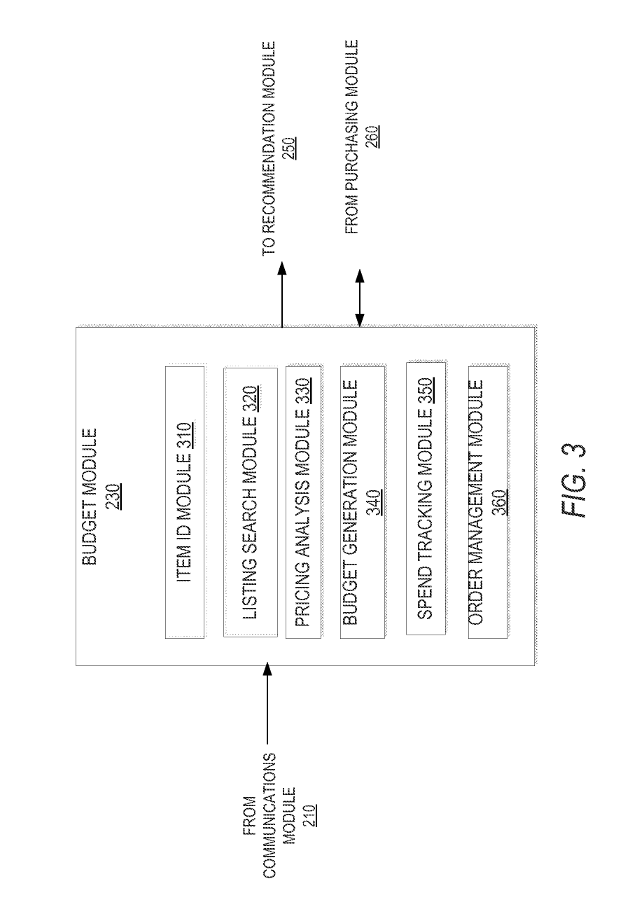

FIG. 3 is a block diagram illustrating the budget module 230 within the budget purchasing system 150, according to some example embodiments. In various example embodiments, the budget module 230 includes one or more of the following modules: an item identification (ID) module 310, a listing search module 320, a pricing analysis module 330, a budget generation module 340, a spend tracking module 350, and an order management module 360. All, or a portion, of the modules 310-360 may communicate with each other, for example, via a network coupling, shared memory, and the like. It is appreciated that the modules 310-360 may be implemented as a single module, combined into other modules, or further subdivided into multiple modules. In various embodiments, the modules or functionality of the budget module 230 may be implemented in the budget purchasing system 150.

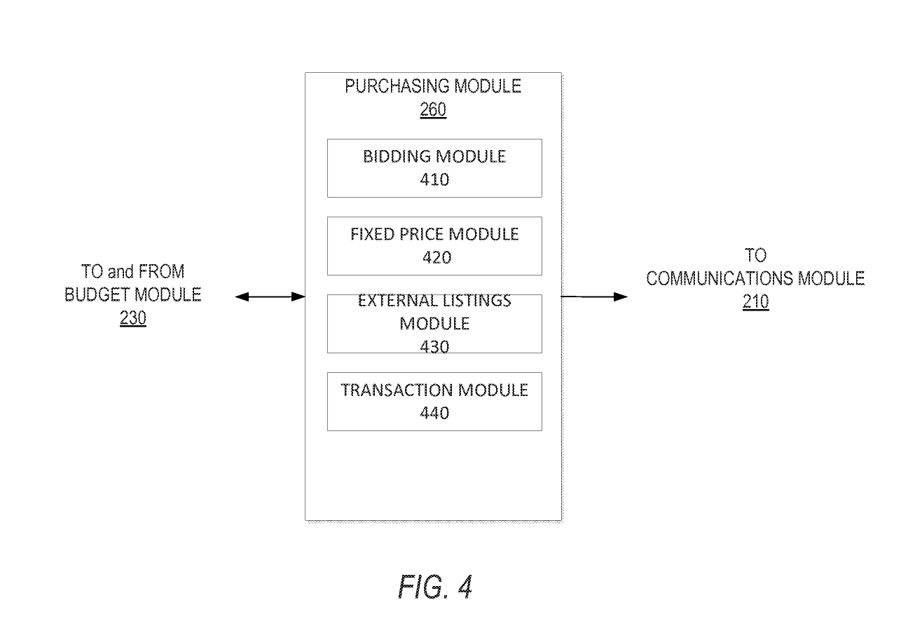

FIG. 4 is a block diagram illustrating a purchasing module 260 within the budget purchasing system 150, according to some example embodiments. In various embodiments, the purchasing module 260 includes one or more of the following modules: a bidding module 410, a fixed price module 420, an external listing module 430, and a transaction module 440. All, or a portion, of the modules 410-440 may communicate with each other, for example, via a network coupling, shared memory, and the like. It is appreciated that the modules 410-440 may be implemented as a single module, combined into other modules, or further subdivided into multiple modules. In various embodiments, the modules or functionality of the purchasing module 260 may be implemented in the budget purchasing system 150.

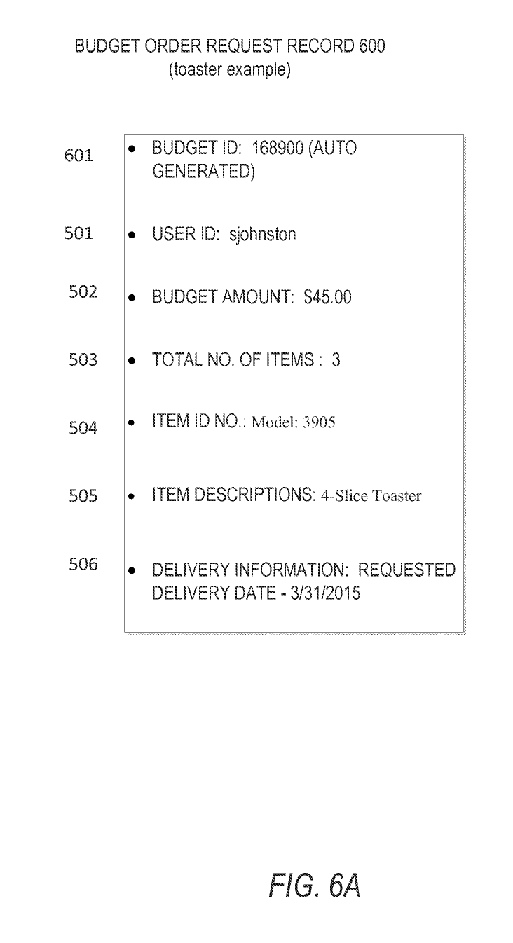

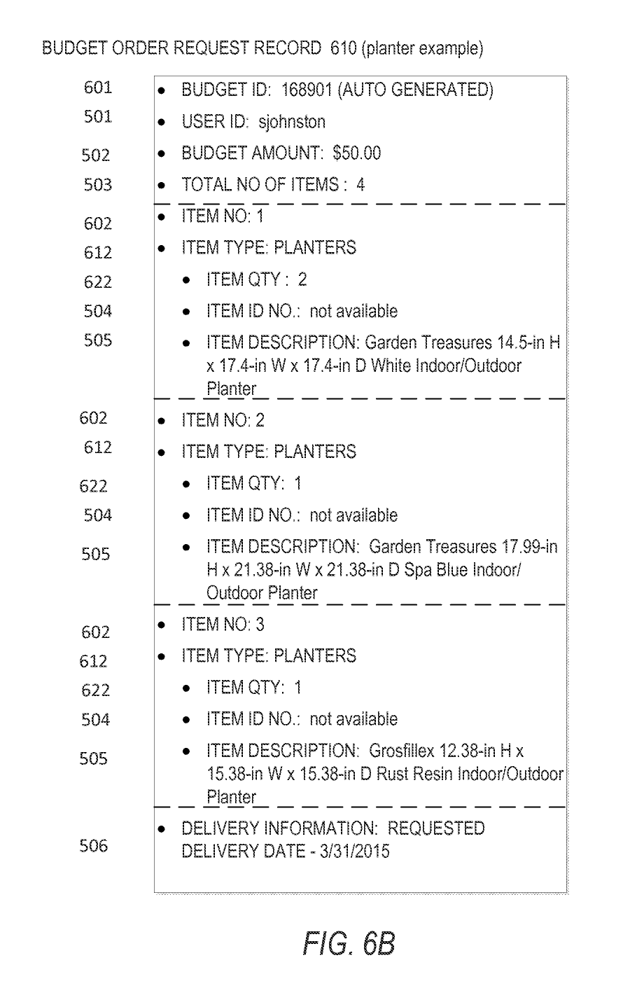

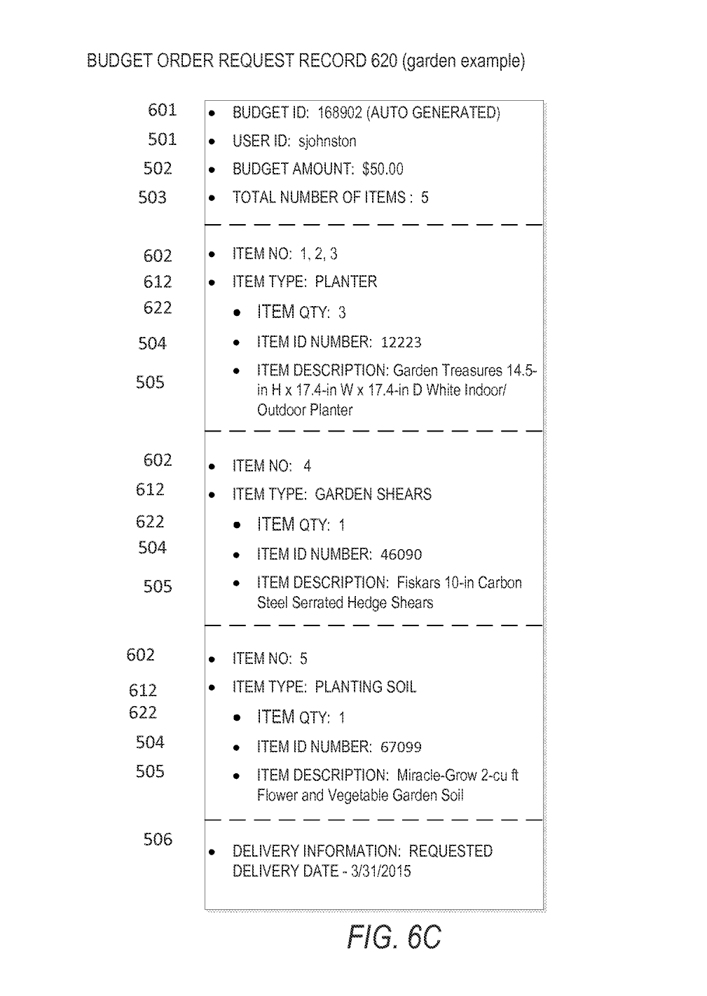

The budget module 230 (including the modules 310-360) and the purchasing module 260 (including the modules 410-440) will be described below in conjunction with three example budget order requests. The budget order request records for the three example budget order requests are shown in FIGS. 6A, 6B, and 6C.

FIG. 6A illustrates a budget order request example for purchasing 3 of the same items. The budget order request record 600 includes the following example fields: budget ID 601, user ID 501, budget amount 502, total NO. of items 503, item ID NO. 504, item descriptions 505, and delivery information 506. This is referred to as the toaster example. There are three total items in this toaster budget order request. The FIGS. 6A and 8D-8G are used to illustrate the toaster example.

FIG. 6B illustrates a budget order request example for purchasing 3 similar items. One of the similar items specifies a quantity of 2. This is referred to as the planter example. There are 3 different variations of planters in this example, which are grouped into a single item type referred to as “planters.” There are 4 total items in this planter budget order request. FIGS. 6B and 7A-7E are used to illustrate the planter example.

FIG. 6C illustrates a budget order request example for purchasing 5 total items for 3 different item types. The item types include “planters,” “garden shears,” and “planting soil,” This is referred to as the garden example. FIGS. 6C and 8A-8C are used to illustrate the garden example.

The item ID module 310 may provide functionality to evaluate the budget order request and identify the individual items specified in the budget order request. In further embodiments, the item ID module 310 may provide functionality to identify whether the individual items are considered same items, similar items, or different items with respect to other individual items specified in the budget order request.

In various embodiments, the budget order request provides item id numbers in various forms and item descriptions. The information from the budget order request may be stored in a budget order request table that may be accessed by the item id module 310 as well as other modules within the budget module 230. Based on the item identification information (e.g., item id numbers and item descriptions) provided in the budget order request, the item id module 310 may use the search engine (described above) to search for listings containing similar item descriptions and item id numbers. These listings identified by the item id module 310 may be used as example listings that are recommended to the user.

In some embodiments, the item id module 310 generates example product information that is provided to the recommendation module 250. The example product information may be stored in a product recommendation table, which may be accessed by the recommendation module 250.

FIG. 8D illustrates an example of a budget order request table 830. The budget order request table 830 includes the columns budget id 601, user id 501, budget amount 502, requested delivery information 506, total number of items 503, item type 612, item no. 602, item id no. 504, and item description 505. For the example shown in FIG. 8D, there is only one record in the budget order request table 830 for illustrative purposes only. The budget order request tables typically include multiple records.

The item description in the budget order request table 830 specifies “4 slice toaster” having an item id no. 504 representing a specific module number 3905. In this toaster example, budget order request table 830 shows a budget amount 502 of $45.00 for a total of 3 items. All three items are the same item. There is a requested delivery date information 506 of Mar. 31, 2015.

Once the item id module 310 accesses the item identification information from the budget order request table 830, the search engine in the networked system 102 may search of listings that include a “4 slice toaster.” An example of search results for the “4 slice toaster” is shown in the product recommendation table 840 in FIG. 8E. The product recommendation table 840 may represent a subset of the search results to illustrate examples of items (or recommendation of items) that the user may be interested in purchasing. The item id module 310 may perform the filtering of the search results to find the most relevant listings or to eliminate duplicative listings. The product recommendation table 840 includes the following columns: budget request id 601, listing id 841, listing title 842, listing price 843, and a user selection 844. The product recommendation table 840 includes five listings for the budget order request associated with the budget id 601 for this toaster example. The five listings are identified by the listing ids 841. The listing title and the listing price for each of the listings are shown in the product recommendation table 840.

In example embodiments, the recommendation module 250 may access the product recommendation table 840 to access data for generating a recommendation. In various examples, the item id module 310 may provide the user with recommended items to determine the most relevant items specified by the user in the budget order request. In the toaster example, the budget order request included item identification information that included an item description and an item id no. representing a model number. In many situations, the item identification information provided in the budget order request may represent example items for the user, rather than the exact item. Although the user, in this example, specified a certain model from a manufacturer, the item id module 310 may be used to expand on the item identification information provided in the budget order request or narrow the item identification information provided in the budget order request. In the toaster example, the item id module 310 identifies similar items from different manufacturers that may be presented to the user in a recommendation.

FIG. 8F illustrates the recommendation 850 that is generated by the recommendation module 250 and sent by the communications module 210 for presentation to the user on the client device. In an example embodiment, the user selects, via one or more user interface elements (not shown), the item 855 representing an “Oster—4 Slice Toaster Black.” The user selection of the item 855 is received by the communications module 210 and may be stored in the product recommendation table 840 in the column 844 (shown in FIG. 8D) in an example embodiment.

In various embodiments, the budget module 230 includes a listing search module 320. The listing search module 320 may use the search engine (described above) to search for listings based on input received that specifies one or more items selected by a user in the item recommendation. For the example shown in FIG. 8F, the item 855 is selected. The selected item represents the “Oster—4 Slice Toaster Black.” The one or more items selected are stored in a database table, such as the item recommendation table 840.

The listing search module 320 accesses the item identification information related to one or more items selected and searches available listings for these selected items. The available listings may include internal listings from the networked system 102. In various embodiments, the available listings may include listings from sources other than the networked system 102. These listings are referred to as external listings in some embodiments. The available listings may include auction formatted listings and fixed price listings in various embodiments.

Once the listing search module 320 searches for available listings, the search results are stored in a table (such as a recommendation table not shown). The purchasing module 260 may access the search results stored in the table that represents the available listings associated with the multiple items associated with the budget order request. In various embodiments, the purchasing module automatically selects listings to purchase the multiple items.

Referring back to FIG. 3, the budget module 230 includes a pricing analysis module 330. The pricing analysis module 230 estimates the current pricing associated with the multiple items specified in the budget order request.

As indicated above, the item id module 310 may provide functionality to identify same items, similar items and different items. The same items are associated with the same item type. The similar items may be associated with the same item type. The different items are associated with different items types. The pricing analysis module 330 may use the designation of the same items, similar items, and different items to estimate the current pricing. For example embodiments, same items may use the same process for estimating the current pricing, similar items may use the same or similar process for estimating the current pricing, and different items typically use a different process for estimating the current pricing. In general, the more diverse the items are, the more diverse searching and navigation is used to identify the available and relevant listings.

Referring to FIG. 6A (toaster example), the budget order request record 600 illustrates three items the user would like to purchase. The three items represent the three same items. The budget order request record 600 is associated with a budget order request that is assigned the budget id of 168900. The budget id may be auto-generated by the budget purchasing system 150. The budget order request record 600 specifies a quantity of three items having the same item id no. and the same item descriptions. The item id module 310 may determine the three same items specified in the budget order request are associated with the same item type.

Referring to FIG. 6B (planter example), the budget order request record 610 illustrates one item type referred to as “planters.” Each item no. 602 specifies an item quantity 622. The item no. 1 indicates a quantity of 2, the item no. 2 indicates a quantity of 1, and the item no. 3 indicates a quantity of 1. The budget order request record 610 indicates a total of four items with three similar items. The information provided in the item description of the three item nos. is used by the item id module 310 to identify the three similar items. The three similar items represent variations of a same type of product (for example, different planters). Based on analysis by the pricing analysis module 330, more than one current pricing may need to be generated for the items 1-4 in the planter example.

Referring to FIG. 6C (garden example), the budget order request record 620 illustrates a total of 5 items. The items 1, 2 and 3 represent the same item, as shown by their item id no. 504 and the item description 505. The item type for items 1, 2, and 3 is referred to as “planter.” The item 4 and the item 5 represent different item types, “garden shears” and “planting soil” respectively. Based on the item id numbers 504 and the item descriptions 505, the item id module 310 identifies the different item types and the quantities associated with the different item types.

The individual items deemed to be same items may use the same estimated current pricing for the individual items. The individual items deemed to be similar items associated with one item type may use the same or similar estimated current pricing for the similar items. The individual items deemed to be different items associated with different item types may use different estimated current pricing for the different items. The estimated current pricing represents individual pricing, which may be the same for same items, the same or similar for similar items, and different for different items. In various examples, similar items may represent variations of the same item (for example, size or color). In other embodiments, the term “item type” may represent a classifications of listings used in a particular system to enable the same or similar type of searching for listings and items.

In various embodiments, the navigation engine (as discussed above) navigates down a category tree comprising a hierarchy of categories (e.g., the category tree structure) until a particular set of listings is reached. For the same or similar items, the navigation engine may navigate down the category tree in the same or similar manner to reach the relevant listings. For the different items, the navigation engine may navigate down the category tree in different manners to reach the relevant listings. For some embodiments, the item type may relate to a classification of listings within a category tree.

The pricing analysis module 330 analyzes historical data available to the networked system 102 related to the multiple items specified in the budget order request. The historical data may be stored within the networked system 102 or external to the networked system 102. The information provided in the budget order request records 600, 610, and 620 may be stored in a budget order request table in example embodiments. For example, the budget order request record 610 (shown in FIG. 6B) may be stored in the budget order request table 700 shown in FIG. 7A. In another example, the budget order request record 620 (shown in FIG. 6C) may be stored in the budget order request table 800 shown in FIG. 8A. In a further example, the budget order request record 610 (shown in FIG. 6A) may be stored in the budget order request table 830 (shown in FIG. 8D). In various embodiments, the pricing analysis module 330 accesses the data from a budget order request table associated with the multiple items specified in the budget order request.

In some situations, the item identification information provided in the budget order requests may not be specific enough or broad enough to identify the most relevant listings or items the user is interested in purchasing. The budget purchasing system 150 is an interactive system with the user and may recommend items to the user to assist in identifying the most relevant listings or items. For example, referring to the budget order request table 830 shown in FIG. 8D, the product information (e.g., item id no. and the item description) specify a 4 slice toaster, with a model number that specifies an Oster toaster. The recommendation table 840 (shown in FIG. 8E) from the budget purchasing system 150 that is presented to the user includes five different items to allow the user to expand his or her product selection to enable the listing search module 320 to find the most relevant listings and enable the pricing analysis module 330 to more accurately estimate the current pricing.

Once the budget module 230 receives the user selection for one or more recommended items, the item id module 310, in combination with the listing search module 320, in an example embodiment, identifies the available listings associated with one or more of the multiple items specified in the budget order request. The user selection for one or more recommended items may also be used by the pricing analysis module 330 to generate current pricing estimates.

The pricing analysis module 330 accesses user specified data (i.e., item identification information and selected item recommendations) stored in various tables to identify for which items to generate the estimated current pricing. The pricing analysis module 330 may also access information generated by the item id module 310 (e.g., item designations as same items, similar items, or different items) and the listing search module 320 (available listings with titles and prices) which are stored in various tables, to obtain the relevant historical data available to the budget purchasing system 150. In some embodiments, the relevant historical data may be used to compute equilibrium pricing for one or more of the multiple items, which may be used as the estimated current pricing. In other embodiments, other types of pricing estimates may be used (for example, some sort of average pricing or medium pricing over a specified timeframe, which may be adjusted or not adjusted by various other market factors or conditions).

Referring to FIG. 7B (the planter example), the estimated budget table 710 illustrates the estimated current pricing computed by the pricing analysis module 330 in an example embodiment. The column 711 represents the estimated current pricing. The estimated current pricing for item 1 is $13.00, $13.00 for item 2, $16.00 for item 3, and $17.50 for item 4.

Once the pricing analysis module 330 determines the estimated current pricing for the various items specified in a budget order request, the budget generation module 340 generates an estimated budget. In the example shown in FIG. 7B, the column 712 represents the estimated budget. The estimated budget for the budget order request is $59.50. The column 713 specifies whether the estimated budget is within the budget amount for the budget order request. For the example shown in table 710, the budget amount shown in the corresponding budget order request record 610 is $50.00 as shown in FIG. 6C. Since the estimated budget of $59.50 is greater than $50.00, the column 713 indicates a “NO” in this example.

Continuing with the planter example shown in the estimated budget table 710, the recommendation module 250 may then access the data stored in the estimated budget table 710 to generate the recommendation 720 shown in FIG. 7C. The recommendation 720 is an example of a recommendation that may be generated by the recommendation module 250 when the estimated budget (e.g., $59.50), shown in column 712, exceeds the budget amount of $50.00 shown in the budget order request table 700 (FIG. 7A). The recommendation data for the recommendation 720 is sent from the recommendation module 250 to the communications module 210, which may then be sent over a network to the client device to be presented to the user.

The recommendation 720 which is presented on the client device to the user includes three recommendations from which the user may select. The user may select via one or more user interface selection elements (not shown) to increase the budget amount to $59.50 in the first option 721, to replace or modify one or more items (i.e., that were specified in the budget order request) in the second option 722, or to cancel the budget order request order in the third option 723.

If the first option 721 is selected from the recommendation 720, then the purchasing module 260 automatically selects from the listings (i.e., identified by the listing search module 320) the listings to purchase the multiple items such that the purchase amount from the identified listings does not exceed the budget amount. In this example, the budget amount of $50.00 has been revised to $59.50 based on the user's selection from the recommendation 720. The revised budget amount may be stored in one or more tables (for example, a budget order request table, an estimated budget table, or a recommendation table).

If the second option 722 is selected from the recommendation 720, then the budget module 230 may update the budget order request table to reflect the replaced or modified items in the budget order request. The original budget order request may be referred to as an updated or revised budget order request. In some embodiments, one or more of the item id module 310, the listing search module 320, the pricing analysis module 330, and the budget generation module 340 may access the information pertaining to the updated items in the budget order request table to perform further processing and functions. In example embodiments, the budget module 230 then estimates the current pricing associated with the updated items in the budget order request, generates an updated estimated budget for the multiple items (specified in the updated budget order request) based on the estimated current pricing (as updated), determines the estimated budget is within the budget amount for the budget order request, and then identifies updated listings associated with the multiple items (specified in the updated budget order request) based on the product identification information and the budget estimates for the individual items specified in the budget order request. In some embodiments, the updated listings represent only those items that have been updated in the budget order request by selecting the second option 722 from the recommendation 720.

In one example, the second option 722 is selected and the items 3 and 4 have been replaced with different items by the user. The estimated budget table 730 in FIG. 7D reflects the updated estimated budget table 710 (i.e., after the items 3 and 4 have been updated by the user) as described in the example above. As shown in the estimated budget table 730, the estimated current pricing for item 3 is $13.00 and the estimated current pricing for item 4 is $10.00. In some embodiments, the pricing analysis module 330 computes the estimated current pricing 711 for the items 3 and 4, and the budget generation module 340 computes the estimated budget 712. The budget generation module 340 may also determine the updated budget is within the budget amount for the budget order request. The listing search module 320 identifies listings associated with the items 3 and 4 in the updated budget order request. The listings identified are based on the item identification information and the budget estimates for the items 3 and 4.

If the third option 723 is selected in the recommendation 720, then the budget order request order is canceled. The budget purchasing system 150 takes no further action.

In some embodiments, after the pricing analysis module 330 estimates the current pricing associated with the individual items specified in the budget order request, the pricing analysis module 330 (alone or in combination with the budget generation module 340) may provide information to the recommendation module 250 to generate a recommendation for spending by item.

FIG. 7E illustrates the recommendation 740 that corresponds to the planter example shown in the estimated budget table 730 (FIG. 7D). In an example embodiment, the recommendation 740 is presented on a user interface of the client device to the user. The recommendation 740 displays the recommended spending by item. In this example, the recommended spending for item 1 is $13.00, the recommended spending for item 2 is $13.00, the recommended spending for item 3 is $13.00, and the recommended spending for item 4 is $10.00. The overall estimated budget for the four items in this budget order request is $49.00. One or more user interface elements (not shown) may be available to the user to approve, deny approval, or modify the recommendation 740.

FIG. 8B illustrates another example of an estimated budget table 810. For this garden example, the estimated budget table 810 is associated with the budget order request table 800 (FIG. 8A) and the budget order request record 620 (FIG. 6C). The budget order request associated with the budget id 168902 specifies a total of 5 items representing three different item types. The item types shown in the estimated budget table 810 include planters, garden shears, and planting soil. The estimated current pricing is shown for each of the five items. The estimated budget for all five items is $50.00, which is the sum of the estimated current pricing for all of the five items. The estimated budget table 810 includes a column 811, which displays the allocated budget by item type. According to the estimated budget table 810, the item type for planters is allocated $30.00 of the estimated budget, the item type for garden shears is allocated $15.00 of the estimated budget and the item type for planting soil is allocated $5.00 of the estimated budget.

In various embodiments, the estimated budget tables may be used by the listing search module 320 to identify the available listings and then to narrow down (or filter) the available listings to those most relevant to fulfilling the budget order request.

In example embodiments, the budget purchasing system 150 is an interactive system. In one example, the budget purchasing system 150 may provide a recommendation to the user regarding the recommended spending by item type for the budget order request. Referring to FIG. 8C, a recommendation 820 is displayed on a user interface of the client device. The recommendation 820 represents an example of a recommendation associated with the budget order request 168902 using information from the estimated budget table 810 (shown in FIG. 8B). The recommendation 820 represents the recommended spending by item type for the budget order request 168902. The recommended spending for the planters (item type) is $30.00. The recommended spending for the garden shears (item type) is $15.00. The recommended spending for the planting soil (item type) is $5.00. One or more user interface elements (not shown) may be available to the user to approve, reject, or modify the recommendation 820.

The budget purchasing system 150 also includes the order management module 360 and the spend tracking module 350. The spend tracking module 350 provides functionality to track spending while the budget purchasing system 150 is fulfilling a budget order request in various embodiments. As one or more items specified in the budget order request are purchased, the remaining balance of the budget amount (specified in the budget order request) is tracked. By tracking the spending in this manner, any unused budget estimates for the purchased item may be allocated to an unpurchased item. In some situations this may provide to the budget purchasing system 150 various alternatives that were not available without increasing the budget estimates for the unpurchased item. For example, a selected auction formatted listing may be replaced with a fixed price listing by increasing the budget estimate for the unpurchased item. The spend tracking module 350 may also influence the decisions made by the order management module 360.

The order management module 360 evaluates the information provided in the budget order request to determine the requested delivery date or other delivery related information and the budget amount. The order management module 360 also evaluates the identified listings associated with the various items specified in the budget order request. The order management module 360 may also use certain criteria or other information to determine the sequence for placing orders or bidding on listings to fulfil the budget order request. Examples of criteria used by the order management module 360 to determine when to place an order for a budget order request include the budget amount, the requested delivery date, estimated current pricing for individual items or item types, budget estimates for individual items, bidding information (e.g., start and end dates of bids for an auction formatted listing), type of listing (auction format listings versus fixed fee listings), and source of the available listing (internal or external to the publication system 142). In various embodiments, the order management module 360 may implement one or more ordering rules to assist in managing the order of placing orders or bids. For example, one ordering rule may be that internal listings are ordered before external listings. Another ordering rule may be to evaluate fixed pricing listings before auction format listings, and if the budget allows for fixed pricing listings, select those first. Various other ordering rules may be implemented by the order management module 360.

After considering a variety of factors, the order management module 360 selects listings from the listings identified by the listing search module 320 that, when purchased from the listings in the order specified by the order management module 360, purchases all items specified by the budget order request within the budget amount, and in some embodiments, by the requested delivery date.

The order management module 360 provides functionality to determine when orders are placed or bidding starts with the selected listings.

FIG. 8G illustrates a selected listing table 860 for the toaster example. In the toaster example, the budget order requests three of the same kind of toasters within a budget of $45.00. The selected listing table 860 includes the following columns: budget id 601, the listing id 841, the quantity (QTY) 861 for a listing, the title 842 of the listing, the listing source 862, the listing types 863, the auction listing—start date 864, the auction listing—end date 865, and the order placement 866. The selected listing table 860 includes four listings which were selected by the order management module 360 from the identified listings (which were identified by the listing search module 320), in an example embodiment. Based on the information provided in the selected listing table 860, there are 3 internal listings and 1 external listing. The quantity of items specified in the listings varies from 1 to 3. In other words, some of the listings include multiple items of the same item. Two of the listings are auction format listings and two of the listings are fixed fee listings. The listings 1600 and 1845 are to be placed first currently. If the purchasing module 260 is successful in closing transactions with the transaction module 440, then the budget order request is fulfilled with three toasters and no further orders or bids are placed by the purchasing module 260.

The listing 1425, which is an auction formatted listing, is to be placed second only if the purchasing module 260 does not win the auction. In the event that the purchasing module is not successful in obtaining any toasters from the listings 1600, 1845, and 1425, then the purchasing module 260 may place an order for with the external listing 2001 to purchase 3 fixed fee toasters.

In some embodiments, the purchasing module 260 includes the bidding module 410, the fixed price listing module 420, the external listing module 430, and the transaction module 440. In some embodiments, the order management module 360 provides instructions to the purchasing module 260 to purchase or bid on items from the listings selected by the order management module 360 in the order specified by the order management module 360. The bidding module 410 provides functionality to place bids on auction format listings when instructed by the order management module 360, in an example embodiment. The fixed price listing module 420 provides functionality to place orders on fixed price listings when instructed by the order management module 360, in an example embodiment. The external listing module 430 provides functionality to recommend external listings for purchase to the user or provide instructions to the user to purchase one or more items in the budget order request from an external listing. In some embodiments, the external listing module 430 may provide functionality to place orders with external systems on behalf of the user. The transaction module 440 may provide functionality to allow for the purchasing module 260 to pay for the orders or bids placed with the selected listings to close the transaction between the seller of the items and the user.

In some embodiments, the budget purchasing system 150 may present the results of the purchase based on the budget order request to users of the budget purchasing system 150. For example, in the garden example, the budget purchasing system 150 may present in a user interface to other users that a user was able to purchase the items specified in a budget order request within the budget. For example, the following statement may be presented to other users “Look at me I had a $50.00 budget for a garden, and this is what I got on from the budget purchasing system 150.”

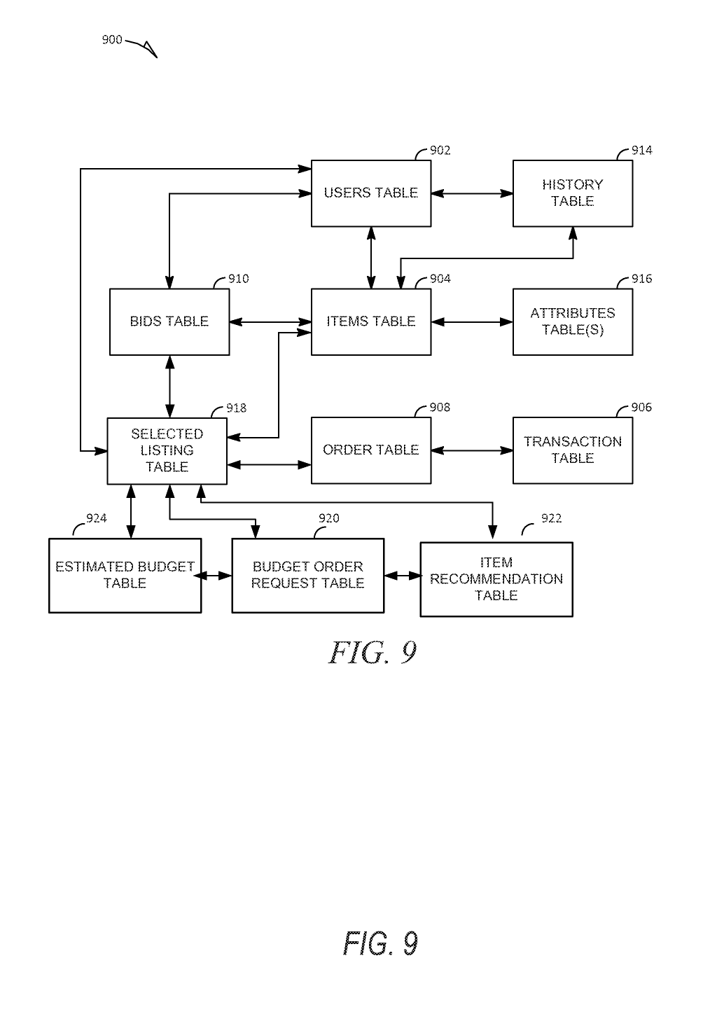

FIG. 9 is a high-level entity-relationship diagram, illustrating various tables 900 that may be maintained within the databases 126 and that are utilized to support the budget purchasing system 150.

A users table 902 contains a record for each registered user of the networked system 102 and may include identifier, address, and financial institution information pertaining to each registered user. A user may operate as a seller, a buyer, or both, within the networked system 102.

The tables 900 also include an items table 904 in which item records are maintained for goods and services that are available to be, or have been, transacted via the networked system 102. Each item record within the items table 904 may further be linked to one or more user records within the user table 902, so as to associate a seller and one or more actual or potential buyers with each item record.

A transaction table 906 contains a record for each transaction (e.g., a purchase or sale transaction) pertaining to items for which records exist within the items table 904.

An order table 908 is populated with order records, with each order record being associated with an order. Each order, in turn, may be with respect to one or more transactions for which records exist within the transaction table 906.

The bid records within a bids table 910 each relate to a bid received at the networked system 102 in connection with an auction format listing supported by the budget purchasing system 150.

A history table 914 maintains a history of transactions to which a user has been a party. One or more attributes tables 916 record attribute information pertaining to items for which records exist within the items table 904.

In addition, in some embodiments, a selected listing table 918, a budget order request table 920, an item recommendation table 922, and an estimated budget table 924, as described in detail above, may also be maintained within the databases 126.

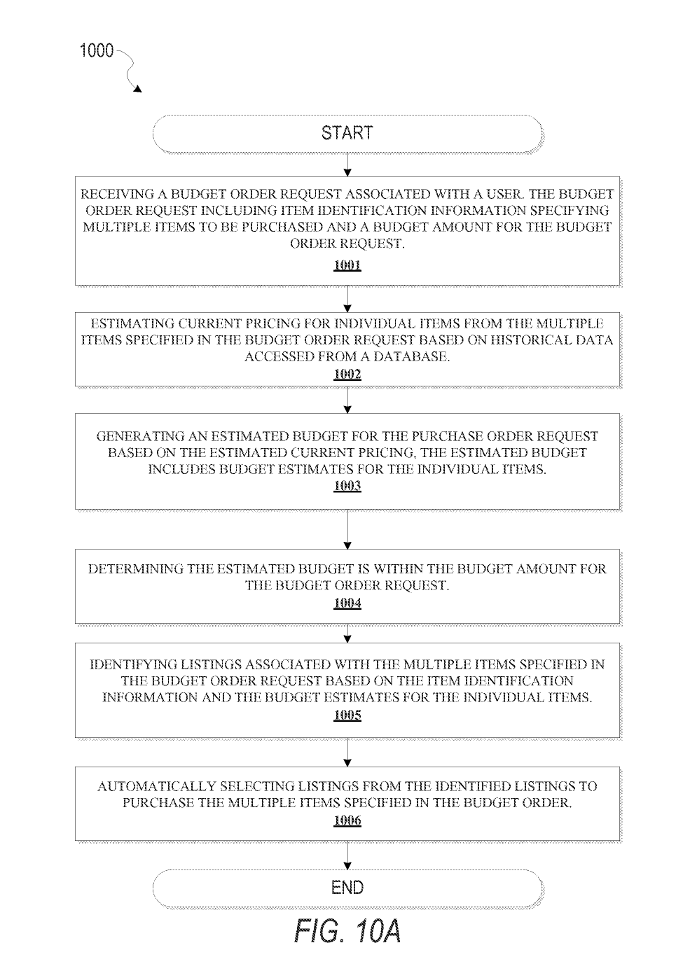

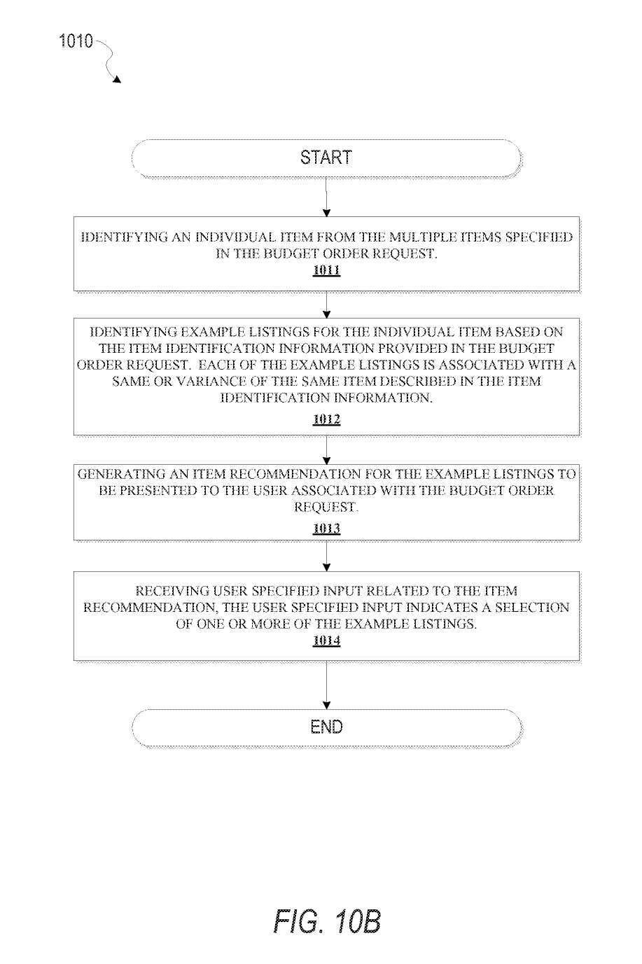

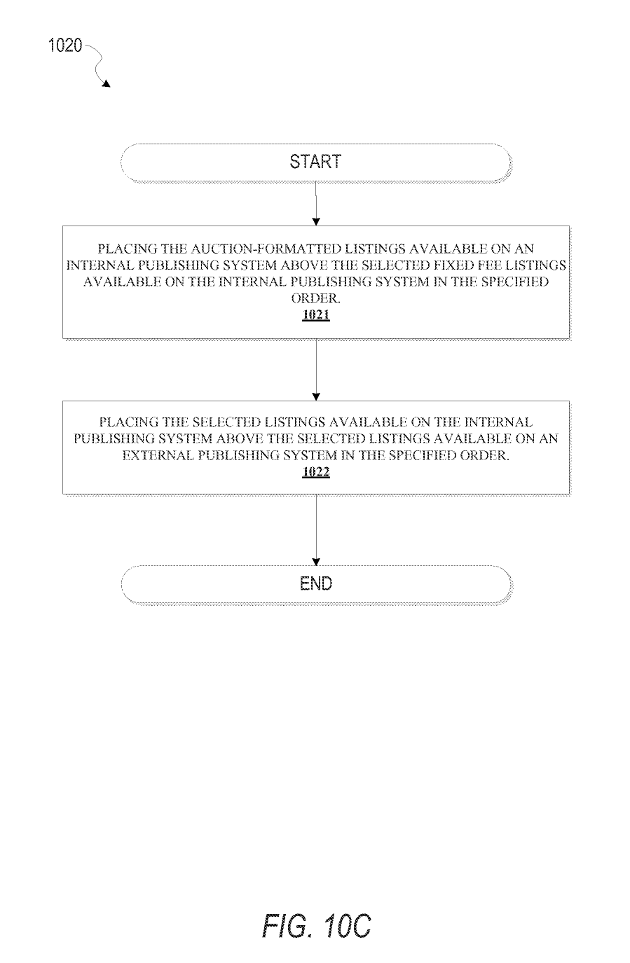

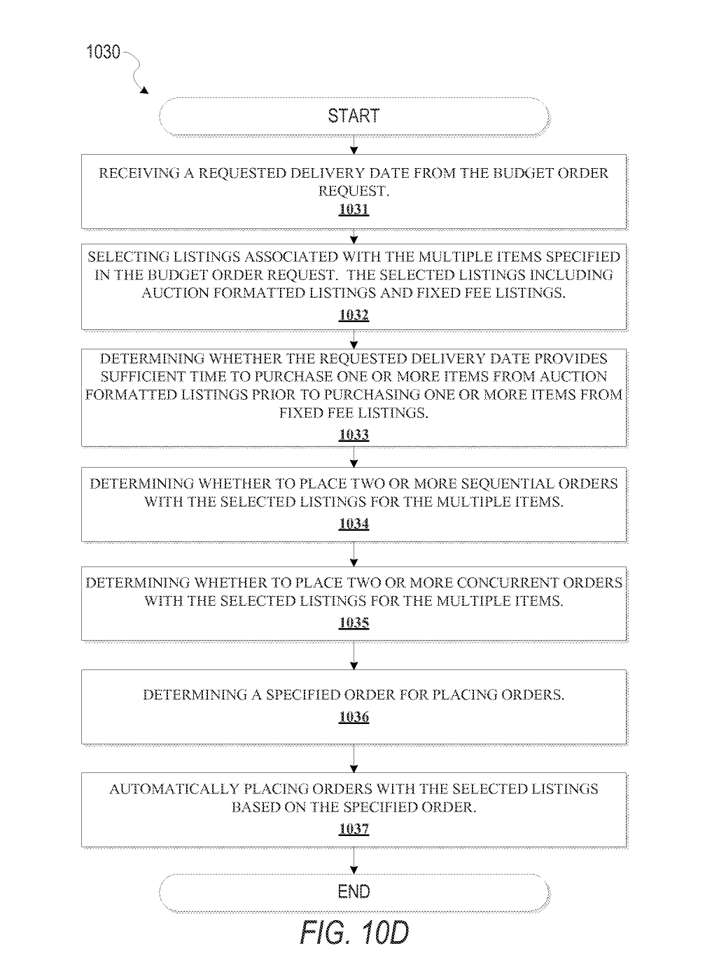

FIGS. 10A-10D illustrates flow diagrams for methods 1000-1030 implemented in various embodiments. In some embodiments, additional operations may be added to each of the methods 1000-1030, or one or more operations may be deleted from each of the methods 1000-1030. In further embodiments, the methods 1000-1030, or variants of these methods, may be combined. The operations performed in the methods 1000-1030 may be performed by one or more components or modules within the budget purchasing system 150.

FIG. 10A describes a method 1000 for purchasing multiple items based on a budget order request, according to example embodiments. The method 1000 includes operations 1001-1006. At operation 1001, a budget order request associated with a user is received. The budget order request includes item identification information specifying multiple items to be purchased and a budget amount for the budget order request. At operation 1002, current pricing is estimated for individual items from the multiple items specified in the budget order request based on historical data accessed from a database. At operation 1003, an estimated budget is generated for the purchase order request based on the estimated current pricing. The estimated budget includes budget estimates for the individual items. At operation 1004, it is determined if the estimated budget is within the budget amount for the budget order request. At operation 1005, listings associated with the multiple items specified in the budget order request are identified based on the item identification information and the budget estimates for the individual items. At operation 1006, listings are automatically selected from the identified listings to purchase the multiple items specified in the budget order request within the budget amount specified in the budget order request.

In various embodiments, automatically selecting listings from the identified listings includes determining a specified order for placing orders with the selected listings based on at least one criterion. In other embodiments, the at least one criteria includes a requested delivery date specified in the budget order request.

In other embodiments, the method 1000 for purchasing multiple items based on a budget order request includes automatically placing orders with the selected listings in the specified order. In some embodiments, the specified order indicates placing orders with at least two of the selected listings concurrently. In other embodiments, the specified order indicates placing orders with at least two of the selecting listings sequentially.

In other embodiments, generating the estimated budget for the purchase order request includes generating a spending recommendation to be presented to the user associated with the budget order request. The spending recommendation indicates proposed spending by one or more of the multiple items specified in the budget order request. User specified input is received related to the spending recommendation.

In various embodiments, the multiple items specified in the budget order request include purchased items and unpurchased items. In example embodiments, the method 1000 for purchasing multiple items based on a budget order request includes purchasing, at a first specified amount, at least one of the items specified in the budget order request from one of the selected listings for the budget order request; determining a balance of the budget amount after subtracting the first specified amount from the budget amount; and generating budget estimates for the unpurchased items based on the balance of the budget amount. Then updated listings associated with the unpurchased items based on the budget estimates for the unpurchased items are identified and listings are automatically selected from the identified updated listings associated with the unpurchased items to purchase the unpurchased items within the balance of the budget amount. In further embodiments, automatically selecting listings from the identified updated listings includes determining an updated specified order based on at least one criterion. In another embodiment, orders are automatically placed with the selected listings from the identified updated listings in the updated specified order.

FIG. 10B describes a method 1010 for identifying an individual item from the multiple items specified in the budget order request, according to example embodiments. The method 1010 includes operations 1011-1014. At operation 1011, an individual item is identified from the multiple items specified in the budget order request. At operation 1012, example listings are identified for the individual item based on the item identification information provided in the budget order request. Each of the example listings is associated with a same or variant of the same item described in the item identification information. At operation 1013, an item recommendation is generated for the example listings to be presented to the user associated with the budget order request. At operation 1014, user specified input related to the item recommendation is received, with the user specified input indicating a selection of one or more of the example listings.

FIG. 10C describes a method 1020 for determining a specified order for placing orders with the selected listings, according to example embodiments. The method 1000 includes operations 1021-1022. At operation 1021, the auction formatted listings available on an internal publishing system are placed above the selected fixed fee listings available on the internal publishing system in the specified order. In other words, orders for auction formatted listings are placed before orders for fixed fee listings in various embodiments. In many situations, the purchaser may get a better deal (or lower price) from the auction-formatted listings than the fixed fee listings. At operation 1022, the selected listings available on the internal publishing system are placed above the selected listings available on an external publishing system in the specified order. In various embodiments, the purchasers are encouraged to purchase items from the internal system before purchasing an item from an external system.

FIG. 10D describes a method 1030 for automatically placing orders with the selected listings based on the specified order, according to example embodiments. The method 1030 includes operations 1031-1037. At operation 1031, a requested delivery date is received from the budget order request. At operation 1032, selecting listings associated with the multiple items specified in the budget order request. The selected listings include auction formatted listings and fixed fee listings. At operation 1033, it is determined whether the requested delivery date provides sufficient time to purchase one or more items from auction formatted listings prior to purchasing one or more items from fixed fee listings. At operation 1034, it is determined whether to place two or more sequential orders with the selected listings for the multiple items. At operation 1035, it is determined whether to place two or more concurrent orders with the selected listings for the multiple items. At operation 1036, a specified order for placing orders is determined. At operation 1037, orders are automatically placed with the selected listings based on the specified order.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and is no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-4 and 10A-10D are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here as those of skill in the art can readily understand how to implement the various embodiments in different contexts from the disclosure contained herein.

### Software Architecture

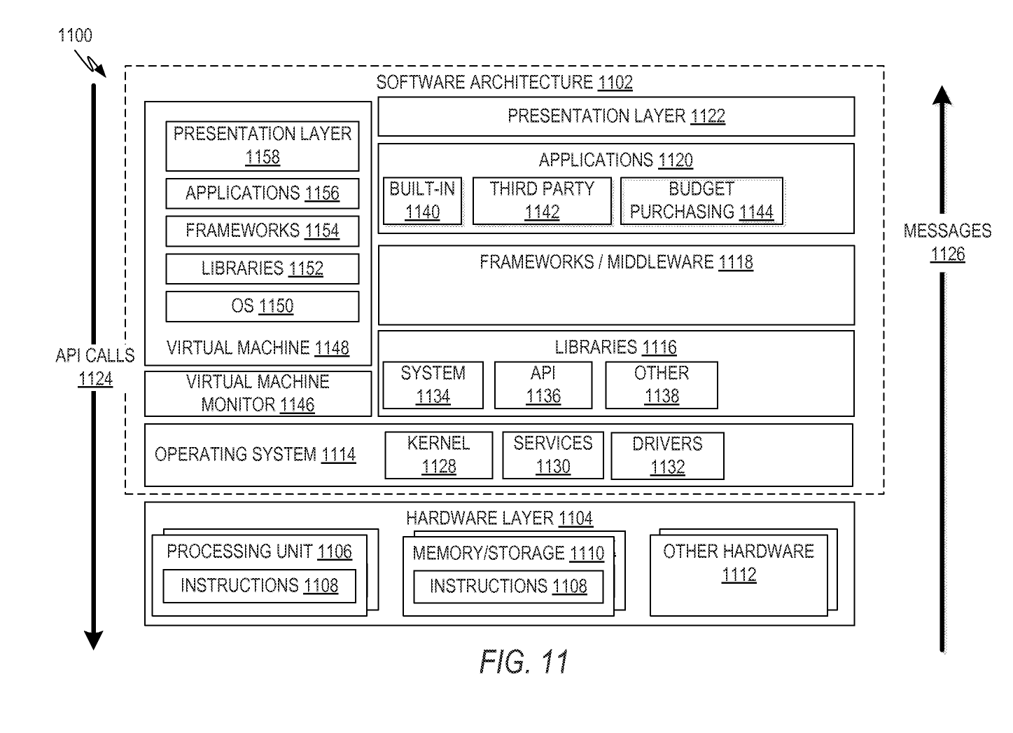

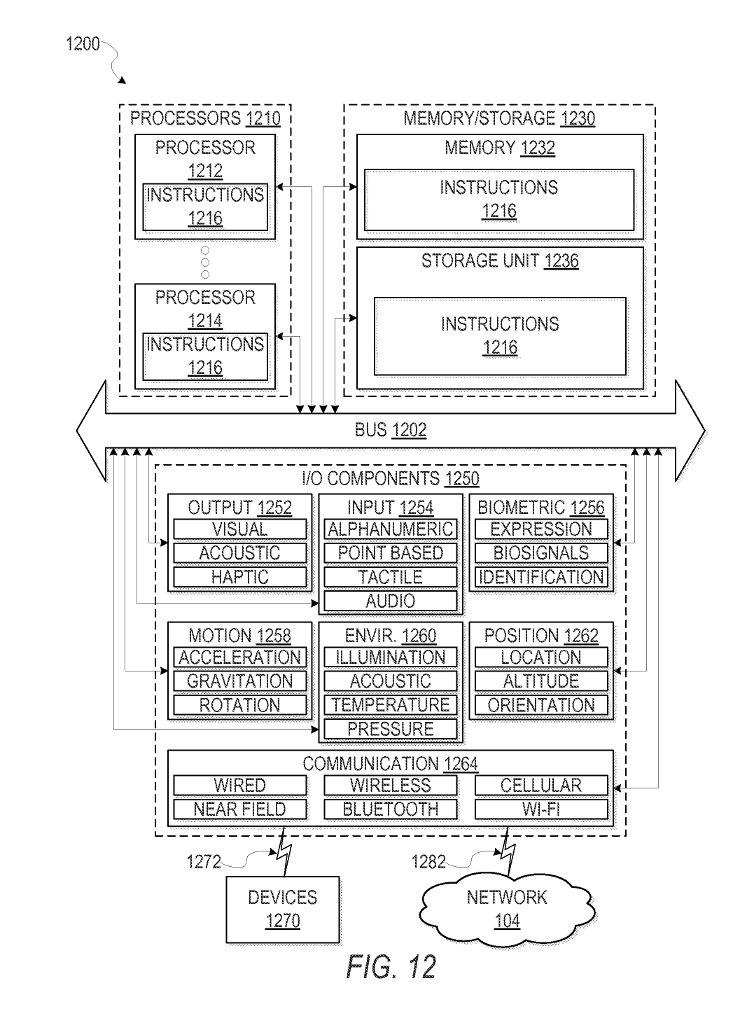

FIG. 11 is a block diagram 1100 illustrating a representative software architecture 1102, which may be used in conjunction with various hardware architectures herein described. FIG. 11 is merely a non-limiting example of a software architecture and it will be appreciated that many other architectures may be implemented to facilitate the functionality described herein. The software architecture 1102 may be executing on hardware such as machine 1200 of FIG. 12 that includes, among other things, processors 1210, memory 1230, and input/output (I/O) components 1250. A representative hardware layer 1104 is illustrated and can represent, for example, the machine 1200 of FIG. 12. The representative hardware layer 1104 comprises one or more processing units 1106 having associated executable instructions 1108. Executable instructions 1108 represent the executable instructions of the software architecture 1102, including implementation of the methods, modules and so forth of FIGS. 1-4 and 10A-10D. For example, as shown in FIG. 2, the executable instructions 108 are executed by the budget purchasing system 150 to implement the communications module 210, the budget module 230, the recommendation module 250, and the purchasing module 260. Hardware layer 1104 also includes memory and/or storage modules 1110, which also have executable instructions 1108. Hardware layer 1104 may also comprise other hardware as indicated by 1112, which represents any other hardware of the hardware layer 1104, such as the other hardware illustrated as part of machine 1200.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120 and presentation layer 1122. Operationally, the applications 1120 and/or other components within the layers may invoke API calls 1124 through the software stack and receive a response, returned values, and so forth illustrated as messages 1126 in response to the API calls 1124. The layers illustrated are representative in nature and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130, and/or drivers 1132). The libraries 1116 may include system 1134 libraries (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks/middleware 1118 (also sometimes referred to as middleware) may provide a higher-level common infrastructure that may be utilized by the applications 1120 and/or other software components/modules. For example, the frameworks 1118 may provide various graphic user interface (GUI) functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 include built-in applications 1140, third party applications 1142, and/or a budget purchasing applications 1144. Examples of representative built-in applications 1140 may include, but are not limited to, a contacts application, a browser application, a book reader application, a location application, a media application, a messaging application, and/or a game application. Third party applications 1142 may include any of the built in applications as well as a broad assortment of other applications. In a specific example, the third party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1142 may invoke the API calls 1124 provided by the mobile operating system such as operating system 1114 to facilitate functionality described herein.

The applications 1120 may utilize built in operating system functions (e.g., kernel 1128, services 1130 and/or drivers 1132), libraries (e.g., system 1134, APIs 1136, and other libraries 1138), and frameworks/middleware 1118 to create user interfaces to interact with users of the system. Alternatively, or additionally, in some systems, interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware machine (such as the machine of FIG. 12, for example). A virtual machine is hosted by a host operating system (operating system 1114 in FIG. 12) and typically, although not always, has a virtual machine monitor 1146, which manages the operation of the virtual machine as well as the interface with the host operating system (i.e., operating system 1114). A software architecture executes within the virtual machine such as an operating system 1150, libraries 1152, frameworks/middleware 1154, applications 1156, and/or presentation layer 1158. These layers of software architecture executing within the virtual machine 1148 can be the same as corresponding layers previously described or may be different.

### Example Machine Architecture and Machine-Readable Medium

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. For example the instructions may cause the machine to execute the flow diagrams of FIGS. 10A-10D. Additionally, or alternatively, the instructions may implement the budget module 230, the recommendation module 250, and the purchasing module 260 of FIGS. 2-4, and so forth. The instructions transform the general, non-programmed machine into a particular machine programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 may include processors 1210, memory/storage 1230, and I/O components 1250, which may be configured to communicate with each other such as via a bus 1202. In an example embodiment, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 1212 and processor 1214 that may execute instructions 1216. The term “processor” is intended to include multi-core processor that may comprise two or more independent processors (sometimes referred to as “cores”) that may execute instructions contemporaneously. Although FIG. 12 shows multiple processors, the machine 1200 may include a single processor with a single core, a single processor with multiple cores (e.g., a multi-core process), multiple processors with a single core, multiple processors with multiples cores, or any combination thereof.

The memory/storage 1230 may include a memory 1232, such as a main memory, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 may also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of processors 1210 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1216. The term “machine-readable medium” shall also be taken to include any medium, or combination of multiple media, that is capable of storing instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1250 may include a wide variety of components to receive input, provide output, produce output, transmit information, exchange information, capture measurements, and so on. The specific I/O components 1250 that are included in a particular machine will depend on the type of machine. For example, portable machines such as mobile phones will likely include a touch input device or other such input mechanisms, while a headless server machine will likely not include such a touch input device. It will be appreciated that the I/O components 1250 may include many other components that are not shown in FIG. 12. The I/O components 1250 are grouped according to functionality merely for simplifying the following discussion and the grouping is in no way limiting. In various example embodiments, the I/O components 1250 may include output components 1252 and input components 1254. The output components 1252 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1250 may include biometric components 1256, motion components 1258, environmental components 1260, or position components 1262 among a wide array of other components. For example, the biometric components 1256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1258 may include acceleration sensor components (e.g., accelerometer), gravitation sensor components, rotation sensor components (e.g., gyroscope), and so forth. The environmental components 1260 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1262 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 104 or devices 1270 via coupling 1282 and coupling 1272, respectively. For example, the communication components 1264 may include a network interface component or other suitable device to interface with the network 104. In further examples, communication components 1264 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a USB).

Moreover, the communication components 1264 may detect identifiers or include components operable to detect identifiers. For example, the communication components 1264 may include Radio Frequency Identification (RFID) tag reader components, NFC smart tag detection components, optical reader components (e.g., an optical sensor to detect one-dimensional bar codes such as UPC bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1264, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 104 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 104 or a portion of the network 104 may include a wireless or cellular network and the coupling 1282 may be a Code Division Multiple Access (CDMA) connection, a Global System for Mobile communications (GSM) connection, or other type of cellular or wireless coupling. In this example, the coupling 1282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1216 may be transmitted or received over the network 104 using a transmission medium via a network interface device (e.g., a network interface component included in the communication components 1264) and utilizing any one of a number of well-known transfer protocols (e.g., Hypertext Transfer Protocol (HTTP)). Similarly, the instructions 1216 may be transmitted or received using a transmission medium via the coupling 1272 (e.g., a peer-to-peer coupling) to devices 1270. The term “transmission medium” shall be taken to include any intangible medium that is capable of storing, encoding, or carrying instructions 1216 for execution by the machine 1200, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method of purchasing multiple items based on a budget order request, comprising:
receiving a budget order request associated with a user, the budget order request including item identification information specifying multiple items to be purchased and a budget amount for the budget order request;
estimating, using a processor of a machine, current pricing for individual items from the multiple items specified in the budget order request based on historical data accessed from a database;
generating, using the processor of the machine, an estimated budget for the purchase order request based on the estimated current pricing, the estimated budget includes budget estimates for the individual items;
determining, using the processor of the machine, the estimated budget is within the budget amount for the budget order request;
identifying listings associated with the multiple items specified in the budget order request based on the item identification information and the budget estimates for the individual items; and
automatically selecting, using the processor of the machine, listings from the identified listings to purchase the multiple items specified in the budget order request within the budget amount specified in the budget order request.

2. The method of claim 1, wherein automatically selecting listings from the identified listings comprises:
determining a specified order for placing orders with the selected listings based on at least one criterion.

3. The method of claim 2, wherein the at least one criterion includes a requested delivery date specified in the budget order request.

4. The method of claim 2, further comprising:
automatically placing orders with the selected listings in the specified order.

5. The method of claim 4, wherein the specified order indicates placing orders with at least two of the selected listings concurrently.

6. The method of claim 4, wherein the specified order indicates placing orders with at least two of the selecting listings sequentially.

7. The method of claim 2,
wherein the selected listings includes selected auction formatted listings and selected fixed fee listings; and
wherein determining a specified order for placing orders with the selected listings comprises:
placing the auction formatted listings available on an internal publishing system above the selected fixed fee listings available on the internal publishing system in the specified order; and
placing the selected listings available on the internal publishing system above the selected listings available on an external publishing system in the specified order.

8. The method of claim 1, wherein generating the estimated budget for the purchase order request comprises:
generating a spending recommendation to be presented to the user associated with the budget order request, the spending recommendation indicating proposed spending by one or more of the multiple items specified in the budget order request; and
receiving user specified input related to the spending recommendation.

9. The method of claim 1,
wherein the multiple items specified in the budget order request include purchased items and unpurchased items; and
further comprising:
purchasing, at a first specified amount, at least one of the items specified in the budget order request from one of the selected listings for the budget order request;
determining a balance of the budget amount after subtracting the first specified amount from the budget amount;
generating budget estimates for the unpurchased items based on the balance of the budget amount;
identifying updated listings associated with the unpurchased items based on the budget estimates for the unpurchased items; and
automatically selecting listings from the identified updated listings associated with the unpurchased items to purchase the unpurchased items within the balance of the budget amount.

10. The method of claim 9, wherein automatically selecting listings from the identified updated listings comprises:
determining an updated specified order based on at least one criterion.

11. The method of claim 10, further comprising:
automatically placing orders with the selected listings from the identified updated listings in the updated specified order.

12. The method of claim 1, wherein estimating the current pricing for the individual items from the multiple items specified in the budget order request comprises:
identifying an individual item from the multiple items specified in the budget order request;
identifying example listings for the individual item based on the item identification information provided in the budget order request, each of the example listings is associated with a same or variant of the same item described in the item identification information;
generating an item recommendation for the example listings to be presented to the user associated with the budget order request;
receiving user specified input related to the item recommendation, the user specified input indicating a selection of one or more of the example listings.

13. The method of claim 12, further comprising:
estimating the current pricing for individual items from the multiple items specified in the budget order request based on the user specified input.

14. The method of claim 13, wherein identifying listings associated with the multiple items specified in the budget order request further comprises:
identifying listings associated with the multiple items specified in the budget order request based on the user specified input and the budget estimates for the individual items.

15. A system, comprising:
at least one processor configured to perform operations for processor-implemented modules including:
a communications module configured to:
receive a budget order request associated with a user, the budget order request includes item identification information specifying multiple items to be purchased and a budget amount for budget order request;
a budget module configured to:
estimate current pricing for individual items from the multiple items specified in the budget order request based on historical data accessed from a database;
generate an estimated budget for the purchase order request based on the estimated current pricing, the estimated budget includes budget estimates for the individual items;
determine the estimated budget is within the budget amount for the budget order request;
identify listings associated with the multiple items specified in the budget order request based on the item identification information and the budget estimates for the individual items; and
automatically select listings from the identified listings to purchase the multiple items specified in the budget order request within the budget amount specified in the budget order request.

16. The system of claim 15, wherein the budget module is further configured to determine a specified order for placing orders with the selected listings based on at least one criteria, the at least one criteria including a requested delivery date specified in the budget order request.

17. The system of claim 15, further comprising:
a purchasing module configured to automatically place orders with the selected listings in the specified order.

18. The system of claim 15, further comprising:
a recommendation module configured to generate a spending recommendation to be presented to the user associated with the budget order request, the spending recommendation indicating proposed spending by one or more of the multiple items specified in the budget order request.

19. The system of claim 15,
wherein the multiple items specified in the budget order request include purchased items and unpurchased items; and
wherein the budget module is configured to:
purchase at least one of the items specified in the budget order request from one of the selected listings for the budget order request;
determine a balance of the budget amount after subtracting the first specified amount from the budget amount;
generate budget estimates for the unpurchased items based on the balance of the budget amount;
identify updated listings associated with the unpurchased items based on the budget estimates for the unpurchased items; and
automatically selecting listings from the identified updated listings associated with the unpurchased items to purchase the unpurchased items within the balance of the budget amount.

20. A non-transitory machine readable medium storing instructions that, when executed by at least one processor of a machine, cause the machine to perform operations comprising:
receiving a budget order request associated with a user, the budget order request including item identification information specifying multiple items to be purchased and a budget amount for the budget order request;
estimating, using a processor of a machine, current pricing for individual items from the multiple items specified in the budget order request based on historical data accessed from a database;
generating, using the processor of the machine, an estimated budget for the purchase order request based on the estimated current pricing, the estimated budget includes budget estimates for the individual items;
determining, using the processor of the machine, the estimated budget is within the budget amount for the budget order request;
identifying listings associated with the multiple items specified in the budget order request based on the item identification information and the budget estimates for the individual items; and
automatically selecting, using the processor of the machine, listings from the identified listings to purchase the multiple items specified in the budget order request within the budget amount specified in the budget order request.
